(19) United States
(12) Patent Application Publication
(10) Pub. No.: US 2026/0189260 A1
(43) Pub. Date: Jul. 2, 2026

(54) WIRELESS AUDIO TRANSMITTING APPARATUS, WIRELESS AUDIO RECEIVING APPARATUS, AND WIRELESS AUDIO OUTPUT SYSTEM INCLUDING SAME

(71) Applicant: LG ELECTRONICS INC., Seoul (KR)

(72) Inventors: Dawoon LEE, Seoul (KR); Seunghyun LEE, Seoul (KR)

(73) Assignee: LG ELECTRONICS INC., Seoul (KR)

(21) Appl. No.: 19/125,213

(22) PCT Filed: Oct. 28, 2022
(86) PCT No.: PCT/KR2022/016681

§ 371 Date: Mar. 20, 2026

(51) Int. Cl. H04B 1/715

(52) U.S. Cl. CPC H04B 1/715

(57) ABSTRACT

The present disclosure relates to a wireless audio transmitting apparatus, a wireless audio receiving apparatus, and a wireless audio output system including same. The wireless audio transmitting apparatus according to an embodiment of the present disclosure comprises a display, a processor that outputs an image signal on the display, and a communication device that wirelessly accesses the wireless audio receiving apparatus through ultra-wideband communication, wherein the communication device outputs a first beacon signal including a beacon sequence number to be changed and channel or preamble code information to be changed, and if a second beacon signal output after the first beacon signal corresponds to the beacon sequence number to be changed, transmits a wireless audio signal to the wireless audio receiving apparatus on the basis of the channel or preamble code information to be changed. Accordingly, frequency hopping can be performed in the ultra-wideband communication by using a beacon signal.

### TECHNICAL FIELD

The present disclosure relates to a wireless audio transmitting device, a wireless audio receiving device, and a wireless audio output system including the same, and more particularly, to a wireless audio transmitting device, a wireless audio receiving device, and a wireless audio output system including the same capable of performing frequency hopping using beacon signals in ultra-wideband communication.

Also, the present disclosure relates to a wireless audio transmitting device, a wireless audio receiving device, and a wireless audio output system including the same capable of stably performing an audio service based on ultra-wideband communication.

### BACKGROUND ART

A wireless audio receiving device wirelessly receives an audio signal from an external wireless audio transmitting device, converts the received audio signal into sound, and outputs the sound.

Meanwhile, to ensure stable audio signal transmission between the wireless audio receiving device and the wireless audio transmitting device, research is being conducted on audio services based on ultra-wideband communication.

Meanwhile, U.S. Pat. No. 7,263,333 (hereinafter, referred to as “prior art 1”) discloses a definition of a new section called Channel Time Allocation Period (CTAP) in the frequency band of ultra-wideband communication and designating a frequency band that should not be used based on measurement results of an interference signal.

However, according to prior art 1, frequency switching is possible only after an interference signal is measured. Moreover, since a separate CTAP section is required for interference measurement, data transmission is not possible during the CTAP section.

Meanwhile, U.S. Pat. No. 7,362,817 (hereinafter, referred to as “prior art 2”) discloses the use of orthogonal time-frequency codes for interference mitigation in ultra-wideband communication.

However, according to prior art 2, to use orthogonal frequency hopping patterns, both the transmitting and receiving devices have to be aware of the frequency hopping pattern, which results in unexpected involvement of an additional message. Furthermore, prior art 2 requires time synchronization between the transmitting and receiving devices and may only be applied to devices between which a connection has already been established.

### DISCLOSURE

### Technical Problem

An object of the present disclosure is to provide a wireless audio transmitting device, a wireless audio receiving device, and a wireless audio output system including the same capable of performing frequency hopping using beacon signals in ultra-wideband communication.

Another object of the present disclosure is to provide a wireless audio transmitting device, a wireless audio receiving device, and a wireless audio output system including the same capable of performing frequency hopping using beacon signals before wireless connection.

Still another object of the present disclosure is to provide a wireless audio transmitting device, a wireless audio receiving device, and a wireless audio output system including the same capable of stably performing audio services based on ultra-wideband communication.

### Technical Solution

To achieve the objects above, a wireless audio transmitting device and a wireless audio system including the same according to one embodiment of the present disclosure comprises a display, a processor configured to output an image signal to the display, and a transceiver configured to wirelessly connect with a wireless audio receiving device through ultra-wideband communication, wherein the transceiver is configured to output a first beacon signal including a beacon sequence number to be changed, a channel to be changed, or preamble code information and, in response to a second beacon signal output after the first beacon signal corresponding to the beacon sequence number to be changed, transmit a wireless audio signal to the wireless audio receiving device based on the channel to be changed or the preamble code information.

Meanwhile, the transceiver may be configured to output the first beacon signal further including current channel information and current preamble code information
and connect to the wireless audio receiving device after outputting the first beacon signal based on a connection request command received from the wireless audio receiving device and, after connecting to the wireless audio receiving device, in response to the output second beacon signal corresponding to the beacon sequence number to be changed, transmit the wireless audio signal to the wireless audio receiving device based on the channel and the preamble code information.

Meanwhile, the transceiver may be configured to transmit the first beacon signal after connecting to the wireless audio receiving device and, in response to the second beacon signal output after the first beacon signal corresponding to the beacon sequence number to be changed, transmit the wireless audio signal to the wireless audio receiving device based on the channel to be changed or the preamble code information.

Meanwhile, the transceiver may be configured to perform scanning of all channels and the entire preamble code information and collect information on idle channels and preamble codes and, based on the collected channel and preamble code information, output the first beacon signal including the beacon sequence number to be changed, the channel to be changed, or the preamble code information.

Meanwhile, the transceiver may be configured to, based on the collected channel and preamble code information, add a beacon sequence number to be additionally changed, a channel to be additionally changed, or preamble code information to the second beacon signal, and output the second beacon signal including the beacon sequence number to be changed, the channel to be changed, or the preamble code information.

Meanwhile, the transceiver may be configured to, based on the collected channel and preamble code information, output a third beacon signal including a beacon sequence number to be additionally changed, a channel to be additionally changed, or preamble code information after the second beacon signal.

Meanwhile, in the case of frequency hopping mode, the transceiver may be configured to perform scanning of all channels and the entire preamble code information and collect information on idle channels and preamble codes and, based on the collected channel and preamble code information, output the first beacon signal including the beacon sequence number to be changed, the channel to be changed, or the preamble code information.

Meanwhile, the transceiver may include a first communication module configured to perform wireless communication based on a first communication standard in a first frequency band and a second communication module configured to perform ultra-wideband communication in a frequency band higher than the first frequency band, wherein a Personal Area Network (PAN) coordinator within the second communication module is configured to output the first beacon signal including the beacon sequence number to be changed, the channel to be changed, or the preamble code information.

Meanwhile, in the case of frequency hopping mode, the PAN coordinator within the transceiver may be configured to perform scanning of all channels and the entire preamble code information and collect information on idle channels and preamble codes and output the first beacon signal including the beacon sequence number to be changed, the channel to be changed, or the preamble code information based on the collected channel and preamble code information.

Meanwhile, the transceiver may be configured to change the interval of changing the channel or preamble code information based on a setting or surrounding wireless environment.

A wireless audio receiving device and a wireless audio system including the same according to one embodiment of the present disclosure comprises a transceiver configured to perform wireless communication with a wireless audio transmitting device through ultra-wideband communication and a sound output device configured to output sound, wherein the transceiver is configured to receive a first beacon signal including a beacon sequence number to be changed, a channel to be changed, or preamble code information and, in response to a second beacon signal received after the first beacon signal corresponding to the beacon sequence number to be changed, receive a wireless audio signal based on the channel to be changed or the preamble code information, and the sound output device is configured to output sound corresponding to the received wireless audio signal.

Meanwhile, the transceiver may be configured to receive the first beacon signal further including current channel information and current preamble code information, transmit a connection request command to the wireless audio transmitting device based on the first beacon signal, connect to the wireless audio transmitting device based on the connection request command, and, in response to the second beacon signal received after connecting to the wireless audio transmitting device corresponding to the beacon sequence number to be changed, receive the wireless audio signal based on the channel and the preamble code information.

Meanwhile, the transceiver may be configured to receive the first beacon signal after connecting to the wireless audio transmitting device and, in response to the second beacon signal received after the first beacon signal corresponding to the beacon sequence number to be changed, receive the wireless audio signal based on the channel to be changed or the preamble code information.

Meanwhile, the transceiver may be configured to perform wireless connection to a second wireless audio transmitting device in response to receiving a third beacon signal including current channel information, current preamble code information, a beacon sequence number to be changed, a channel to be changed, or preamble code information from the second wireless audio transmitting device.

Meanwhile, in response to performing wireless connection to the second wireless audio transmitting device, the transceiver may be configured to terminate wireless connection to the wireless audio transmitting device.

Meanwhile, in response to a fourth beacon signal received after connecting to the second wireless audio transmitting device corresponding to the beacon sequence number to be changed, the transceiver may be configured to receive a second wireless audio signal based on the channel and the preamble code information, and the sound output device may be configured to output a second sound corresponding to the second wireless audio signal received.

### Advantageous Effects

A wireless audio transmitting device and a wireless audio system including the same according to one embodiment of the present disclosure comprises a display, a processor configured to output an image signal to the display, and a transceiver configured to wirelessly connect with a wireless audio receiving device through ultra-wideband communication, wherein the transceiver is configured to output a first beacon signal including a beacon sequence number to be changed, a channel to be changed, or preamble code information and, in response to a second beacon signal output after the first beacon signal corresponding to the beacon sequence number to be changed, transmit a wireless audio signal to the wireless audio receiving device based on the channel to be changed or the preamble code information. Accordingly, frequency hopping may be performed in ultra-wideband communication using beacon signals. Since channel and preamble code information are utilized, frequency hopping may be performed in ultra-wideband communication while interference is avoided efficiently. Also, audio services based on ultra-wideband communication may be performed stably.

Meanwhile, the transceiver may be configured to output a first beacon signal further including current channel information and current preamble code information and connect to the wireless audio receiving device after outputting the first beacon signal based on a connection request command received from the wireless audio receiving device and, after connecting to the wireless audio receiving device, if the second beacon signal corresponds to the beacon sequence number to be changed, transmit the wireless audio signal to the wireless audio receiving device based on the channel and the preamble code information. Accordingly, frequency hopping may be performed in ultra-wideband communication using beacon signals before wireless connection.

Meanwhile, the transceiver may be configured to transmit the first beacon signal after connecting to the wireless audio receiving device and, in response to the second beacon signal output after the first beacon signal corresponding to the beacon sequence number to be changed, transmit the wireless audio signal to the wireless audio receiving device based on the channel to be changed or the preamble code information. Accordingly, frequency hopping may be performed in ultra-wideband communication using beacon signals.

Meanwhile, the transceiver may be configured to perform scanning of all channels and the entire preamble code information and collect information on idle channels and preamble codes and, based on the collected channel and preamble code information, output a first beacon signal including the beacon sequence number to be changed and the channel or preamble code to be changed. Accordingly, frequency hopping may be performed in ultra-wideband communication using beacon signals.

Meanwhile, the transceiver may be configured to, based on the collected channel and preamble code information, add a beacon sequence number to be additionally changed, a channel to be additionally changed, or preamble code information to the second beacon signal, and output the second beacon signal including the beacon sequence number to be changed, the channel to be changed, or the preamble code information. Accordingly, frequency hopping may be performed in ultra-wideband communication using beacon signals.

Meanwhile, the transceiver may be configured to, based on the collected channel and preamble code information, output a third beacon signal including a beacon sequence number to be additionally changed, a channel to be additionally changed, or preamble code information after the second beacon signal. Accordingly, frequency hopping may be performed in ultra-wideband communication using beacon signals.

Meanwhile, in the case of frequency hopping mode, the transceiver may be configured to perform scanning of all channels and the entire preamble code information and collect information on idle channels and preamble codes and, based on the collected channel and preamble code information, output the first beacon signal including the beacon sequence number to be changed, the channel to be changed, or the preamble code information. Accordingly, frequency hopping may be performed in ultra-wideband communication using beacon signals.

Meanwhile, the transceiver may include a first communication module configured to perform wireless communication based on a first communication standard in a first frequency band and a second communication module configured to perform ultra-wideband communication in a frequency band higher than the first frequency band, wherein a Personal Area Network (PAN) coordinator within the second communication module is configured to output the first beacon signal including the beacon sequence number to be changed, the channel to be changed, or the preamble code information. Accordingly, frequency hopping may be performed in ultra-wideband communication using beacon signals.

Meanwhile, in the case of frequency hopping mode, the PAN coordinator within the transceiver may be configured to perform scanning of all channels and the entire preamble code information and collect information on idle channels and preamble codes and output the first beacon signal including the beacon sequence number to be changed, the channel to be changed, or the preamble code information based on the collected channel and preamble code information. Accordingly, frequency hopping may be performed in ultra-wideband communication using beacon signals.

Meanwhile, the transceiver may be configured to change the interval of changing the channel or preamble code information based on a setting or surrounding wireless environment. Accordingly, frequency hopping may be performed in ultra-wideband communication using beacon signals.

A wireless audio receiving device and a wireless audio system including the same according to one embodiment of the present disclosure comprises a transceiver configured to perform wireless communication with a wireless audio transmitting device through ultra-wideband communication and a sound output device configured to output sound, wherein the transceiver is configured to receive a first beacon signal including a beacon sequence number to be changed, a channel to be changed, or preamble code information and, in response to a second beacon signal received after the first beacon signal corresponding to the beacon sequence number to be changed, receive a wireless audio signal based on the channel to be changed or the preamble code information, and the sound output device is configured to output sound corresponding to the received wireless audio signal. Accordingly, frequency hopping may be performed in ultra-wideband communication using beacon signals. Since channel and preamble code information are utilized, frequency hopping may be performed in ultra-wideband communication while interference is avoided efficiently. Also, audio services based on ultra-wideband communication may be performed stably.

Meanwhile, the transceiver may be configured to receive a first beacon signal further including current channel information and current preamble code information, transmit a connection request command to the wireless audio transmitting device based on the first beacon signal, connect to the wireless audio transmitting device based on the connection request command, and, in response to the second beacon signal received after connecting to the wireless audio transmitting device corresponding to the beacon sequence number to be changed, receive the wireless audio signal based on the channel and the preamble code information. Accordingly, frequency hopping may be performed in ultra-wideband communication using beacon signals before wireless connection.

Meanwhile, the transceiver may be configured to receive the first beacon signal after connecting to the wireless audio transmitting device and, in response to the second beacon signal received after the first beacon signal corresponding to the beacon sequence number to be changed, receive the wireless audio signal based on the channel to be changed or the preamble code information. Accordingly, frequency hopping may be performed in ultra-wideband communication using beacon signals.

Meanwhile, the transceiver may be configured to perform wireless connection to the second wireless audio transmitting device in response to receiving a third beacon signal including current channel information, current preamble code information, a beacon sequence number to be changed, a channel to be changed, or preamble code information from a second wireless audio transmitting device. Accordingly, wireless connection with the second wireless audio transmitting device based on ultra-wideband communication may be performed using beacon signals.

Meanwhile, in response to performing wireless connection to the second wireless audio transmitting device, the transceiver may be configured to terminate wireless connection to the wireless audio transmitting device. Accordingly, frequency hopping may be performed in ultra-wideband communication using beacon signals.

Meanwhile, in response to a fourth beacon signal received after connecting to the second wireless audio transmitting device corresponding to the beacon sequence number to be changed, the transceiver may be configured to receive a second wireless audio signal based on the channel and the preamble code information, and the sound output device may be configured to output a second sound corresponding to the second wireless audio signal received. Accordingly, frequency hopping may be performed in ultra-wideband communication using beacon signals. Also, audio services based on ultra-wideband communication may be performed stably.

### BRIEF DESCRIPTION OF THE DRAWINGS

FIGS. 1A to 1E are diagrams illustrating a wireless audio system including a wireless audio receiving device and a wireless audio transmitting device according to various embodiments of the present disclosure.

FIG. 2A is an example of an internal block diagram of the wireless audio receiving device of FIGS. 1A to 1E.

FIG. 2B is an example of an internal block diagram of the wireless audio transmitting device of FIGS. 1A to 1E.

FIGS. 3A to 8B are diagrams for explaining an operation of a wireless audio receiving device or a wireless audio transmitting device according to an embodiment of the present disclosure.

FIG. 9A is an example of a flowchart showing a method of operating a wireless audio output system according to an embodiment of the present disclosure.

FIG. 9B is another example of a flowchart showing a method of operating a wireless audio output system according to an embodiment of the present disclosure.

FIGS. 10A to 11B are diagrams referred to in description of FIG. 9A or FIG. 9B.

FIG. 12 is yet another example of a flowchart showing a method of operating a wireless audio output system according to an embodiment of the present disclosure.

FIGS. 13 to 14B are diagrams referred to in description of FIG. 12.

### DETAILED DESCRIPTION OF THE PREFERRED EMBODIMENTS

Hereinafter, the present disclosure will be described in more detail with reference to the drawings.

The suffixes such as “module” and “unit” may be used to refer to elements or components. Use of such suffixes herein is merely intended to facilitate description of the specification, and the suffixes do not have any special meaning or function. Accordingly, the “module” and “unit” may be used interchangeably.

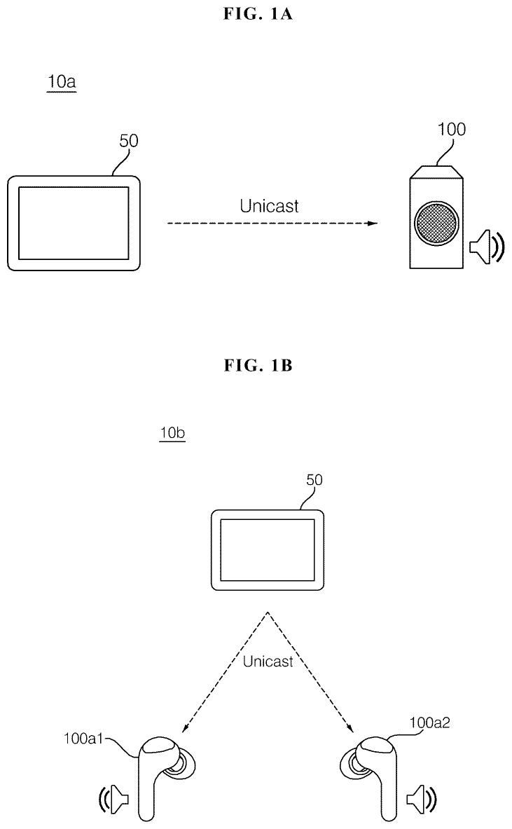

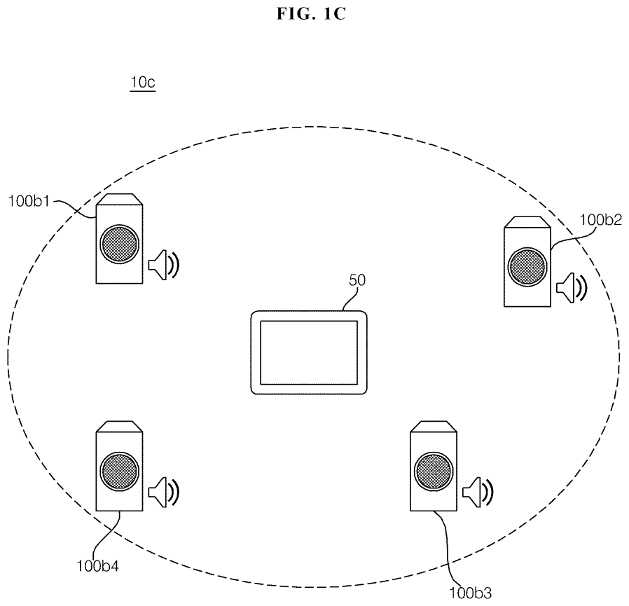

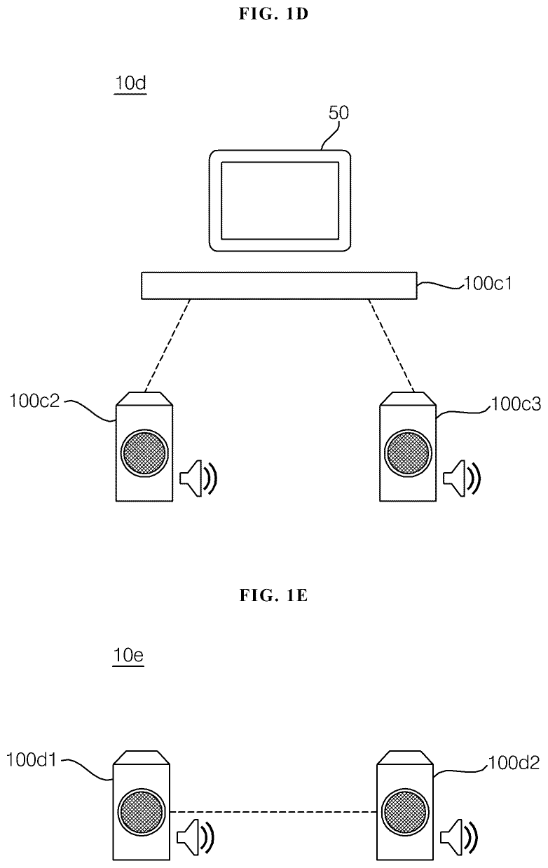

FIGS. 1A to 1E are diagrams illustrating a wireless audio system including a wireless audio receiving device and a wireless audio transmitting device according to various embodiments of the present disclosure.

First, FIG. 1A illustrates a wireless audio system 10a according to an embodiment of the present disclosure.

Referring to FIG. 1A, the wireless audio system 10a according to an embodiment of the present disclosure may include a wireless audio transmitting device 50 and a wireless audio receiving device 100.

In particular, in the wireless audio system 10a, the wireless audio transmitting device 50 and the wireless audio receiving device 100 may correspond one-to-one, based on a unicast method.

The wireless audio transmitting device 50 may include a first communication module 135a wirelessly transmitting a first audio signal based on a first communication standard of a first frequency band, and a second communication module 135b wirelessly transmitting a second audio signal based on a second communication standard of a second frequency band greater than the first frequency band.

Meanwhile, the wireless audio receiving device 100 may include a first communication module 135a wirelessly receiving a first audio signal according to the first communication standard of a first frequency band, and a second communication module 135b wirelessly receiving a second audio signal according to the second communication standard of a second frequency band greater than the first frequency band.

For example, if the wireless environment becomes complex and the packet error rate of the first audio signal exceeds a predetermined threshold while configured to output a first sound based on a first audio signal wirelessly received through the first communication module 135a according to the first communication standard of a first frequency band, the wireless audio receiving device 100 may be configured to output a second sound based on a second audio signal wirelessly received through the second communication module 135b according to the second communication standard of a second frequency band.

Accordingly, even though the wireless environment is complex, it is possible to stably receive audio wirelessly and output sound.

Meanwhile, the wireless audio receiving device 100 may be configured to receive a beacon signal from the first wireless audio transmitting device 50a for each period P_{c} corresponding to the first active period Pₐ and the first inactive period P_{b}, transmit a connection request command to the second wireless audio transmitting device 50b if a second beacon signal from the second wireless audio transmitting device 50b is received during the first inactive period P_{b} while searching for additional devices, and, based on the connection request command, establish an additional wireless connection with the second wireless audio transmitting device 50b based on ultra-wideband communication while being wirelessly connected with the first wireless audio transmitting device 50a. Accordingly, frequency hopping may be performed in ultra-wideband communication using beacon signals.

Next, FIG. 1B illustrates a wireless audio system 10b according to another embodiment of the present disclosure.

Referring to FIG. 1B, the wireless audio system 10b according to another embodiment of the present disclosure may include a wireless audio transmitting device 50 and a plurality of wireless audio receiving devices 100a1 and 100a2.

In particular, the wireless audio system 10b may include a wireless audio transmitting device 50 and a plurality of wireless audio receiving devices 100a1 and 100a2, based on a unicast method.

For example, when wireless audio signals of a first channel to a second channel are output from the wireless audio transmitting device 50, a wireless audio signal of the first channel may be transmitted to a first wireless audio receiving device 100a1 among a plurality of wireless audio receiving devices 100a1 and 100a2, and a wireless audio signal of the second channel may be transmitted to a second wireless audio receiving device 100a2. Accordingly, even though the wireless environment is complex, it is possible to stably receive audio wirelessly and output sound.

Meanwhile, if the wireless environment becomes complex and the packet error rate of the first audio signal exceeds a predetermined threshold while configured to output a first sound based on a first audio signal wirelessly received through the first communication module 135a according to the first communication standard of the first frequency band, each of the wireless audio receiving devices 100a1, 100a2 may be configured to output a second sound based on a second audio signal wirelessly received through the second communication module 135b according to the second communication standard of the second frequency band. Accordingly, even though the wireless environment is complex, it is possible to stably receive audio wirelessly and output sound.

Meanwhile, each of the wireless audio receiving devices 100a1, 100a2 may be configured to receive a beacon signal from the first wireless audio transmitting device 50a for each period P_{c} corresponding to the first active period Pₐ and the first inactive period P_{b}, transmit a connection request command to the second wireless audio transmitting device 50b if a second beacon signal from the second wireless audio transmitting device 50b is received during the first inactive period P_{b} while searching for additional devices, and, based on the connection request command, establish an additional wireless connection with the second wireless audio transmitting device 50b based on ultra-wideband communication while being wirelessly connected with the first wireless audio transmitting device 50a. Accordingly, frequency hopping may be performed in ultra-wideband communication using beacon signals.

At this time, the plurality of wireless audio receiving devices 100a1 and 100a2 may be left and right wireless audio receiving devices, respectively.

Next, FIG. 1C illustrates a wireless audio system 10c according to another embodiment of the present disclosure.

Referring to FIG. 1C, a wireless audio system 10c according to another embodiment of the present disclosure may include a wireless audio transmitting device 50 and a plurality of wireless audio receiving devices 100b1 to 100b4.

In particular, the wireless audio system 10c may include a wireless audio transmitting device 50 and a plurality of wireless audio receiving devices 100b1 to 100b4, based on a broadcast method.

For example, when wireless audio signals of first to fourth channels are output from the wireless audio transmitting device 50, a wireless audio signal of a first channel may be transmitted to a first wireless audio receiving device 100b1 among a plurality of wireless audio receiving devices 100b1 to 100b4, a wireless audio signal of a second channel may be transmitted to a second wireless audio receiving device 100b2, a wireless audio signal of a third channel may be transmitted to a third wireless audio receiving device 100b3, and a wireless audio signal of a fourth channel may be transmitted to a fourth wireless audio receiving device 100b4. Accordingly, even though the wireless environment is complex, it is possible to stably receive audio wirelessly and output sound.

Meanwhile, if the wireless environment becomes complex and the packet error rate of the first audio signal exceeds a predetermined threshold while configured to output a first sound based on a first audio signal wirelessly received through the first communication module 135a according to the first communication standard of the first frequency band, each of the wireless audio receiving devices 100b1-100b4 may be configured to output a second sound based on a second audio signal wirelessly received through the second communication module 135b according to the second communication standard of the second frequency band. Accordingly, even though the wireless environment is complex, it is possible to stably receive audio wirelessly and output sound.

Meanwhile, each of the wireless audio receiving devices 100b1-100b4 may be configured to receive a beacon signal from the first wireless audio transmitting device 50a for each period P_{c} corresponding to the first active period Pₐ and the first inactive period P_{b}, transmit a connection request command to the second wireless audio transmitting device 50b if a second beacon signal from the second wireless audio transmitting device 50b is received during the first inactive period P_{b} while searching for additional devices, and, based on the connection request command, establish an additional wireless connection with the second wireless audio transmitting device 50b based on ultra-wideband communication while being wirelessly connected with the first wireless audio transmitting device 50a. Accordingly, frequency hopping may be performed in ultra-wideband communication using beacon signals.

Next, FIG. 1D illustrates a wireless audio system 10d according to another embodiment of the present disclosure.

Referring to FIG. 1D, the wireless audio system 10d according to another embodiment of the present disclosure may include a wireless audio transmitting device 50 and a plurality of wireless audio receiving devices 100c1 to 100c3.

In particular, the wireless audio system 10d may include a wireless audio transmitting device 50 and a plurality of wireless audio receiving devices 100c1 to 100c3, based on a unicast method.

For example, when wireless audio signals of first to third channels are output from the wireless audio transmitting device 50, a wireless audio signal of a first channel may be transmitted to a first wireless audio receiving device 100c1 among a plurality of wireless audio receiving devices 100c1 to 100c3, a wireless audio signal of a second channel may be transmitted to a second wireless audio receiving device 100c2, and a wireless audio signal of a third channel may be transmitted to a third wireless audio receiving device 100c3.

As another example, when wireless audio signals of first to third channels are output from the wireless audio transmitting device 50, wireless audio signals of a first channel to a third channel may be transmitted to a first wireless audio receiving device 100c1 among a plurality of wireless audio receiving devices 100c1 to 100c3, the first wireless audio receiving device 100c1 may be configured to output wireless audio signals of second to third channels, a wireless audio signal of the second channel may be transmitted to a second wireless audio receiving device 100c2, and a wireless audio signal of the third channel may be transmitted to a third wireless audio receiving device 100c3.

Accordingly, even though the wireless environment is complex, it is possible to stably receive audio wirelessly and output sound.

Meanwhile, if the wireless environment becomes complex and the packet error rate of the first audio signal exceeds a predetermined threshold while configured to output a first sound based on a first audio signal wirelessly received through the first communication module 135a according to the first communication standard of the first frequency band, each of the wireless audio receiving devices 100c1-100c3 may be configured to output a second sound based on a second audio signal wirelessly received through the second communication module 135b according to the second communication standard of the second frequency band. Accordingly, even though the wireless environment is complex, it is possible to stably receive audio wirelessly and output sound.

Meanwhile, each of the wireless audio receiving devices 100c1-100c3 may be configured to receive a beacon signal from the first wireless audio transmitting device 50a for each period P_{c} corresponding to the first active period Pₐ and the first inactive period P_{b}, transmit a connection request command to the second wireless audio transmitting device 50b if a second beacon signal from the second wireless audio transmitting device 50b is received during the first inactive period P_{b} while searching for additional devices, and, based on the connection request command, establish an additional wireless connection with the second wireless audio transmitting device 50b based on ultra-wideband communication while being wirelessly connected with the first wireless audio transmitting device 50a. Accordingly, frequency hopping may be performed in ultra-wideband communication using beacon signals.

Next, FIG. 1E illustrates a wireless audio system 10e according to another embodiment of the present disclosure.

Referring to FIG. 1E, a wireless audio system 10e according to another embodiment of the present disclosure may include a plurality of wireless audio receiving devices 100d1 and 100d2.

In particular, the wireless audio system 10e may include a plurality of wireless audio receiving devices 100d1 and 100d2, based on a unicast method.

For example, when a wireless audio signal is output from the first wireless audio receiving device 100d1, the wireless audio signal may be transmitted to the second wireless audio receiving device 100d2.

Accordingly, even though the wireless environment is complex, it is possible to stably receive audio wirelessly and output sound.

Meanwhile, if the wireless environment becomes complex and the packet error rate of the first audio signal exceeds a predetermined threshold while configured to output a first sound based on a first audio signal wirelessly received through the first communication module 135a according to the first communication standard of the first frequency band, each of the wireless audio receiving devices 100d1, 100d2 may be configured to output a second sound based on a second audio signal wirelessly received through the second communication module 135b according to the second communication standard of the second frequency band. Accordingly, even though the wireless environment is complex, it is possible to stably receive audio wirelessly and output sound.

Meanwhile, each of the wireless audio receiving devices 100d1, 100d2 may be configured to receive a beacon signal from the first wireless audio transmitting device 50a for each period P_{c} corresponding to the first active period Pₐ and the first inactive period P_{b}, transmit a connection request command to the second wireless audio transmitting device 50b if a second beacon signal from the second wireless audio transmitting device 50b is received during the first inactive period P_{b} while searching for additional devices, and, based on the connection request command, establish an additional wireless connection with the second wireless audio transmitting device 50b based on ultra-wideband communication while being wirelessly connected with the first wireless audio transmitting device 50a. Accordingly, frequency hopping may be performed in ultra-wideband communication using beacon signals.

Meanwhile, the wireless audio transmitting device 50 illustrated in FIGS. 1A to 1E may be a mobile terminal, a TV, a monitor, a tablet, a home appliance, a vehicle display device, and the like.

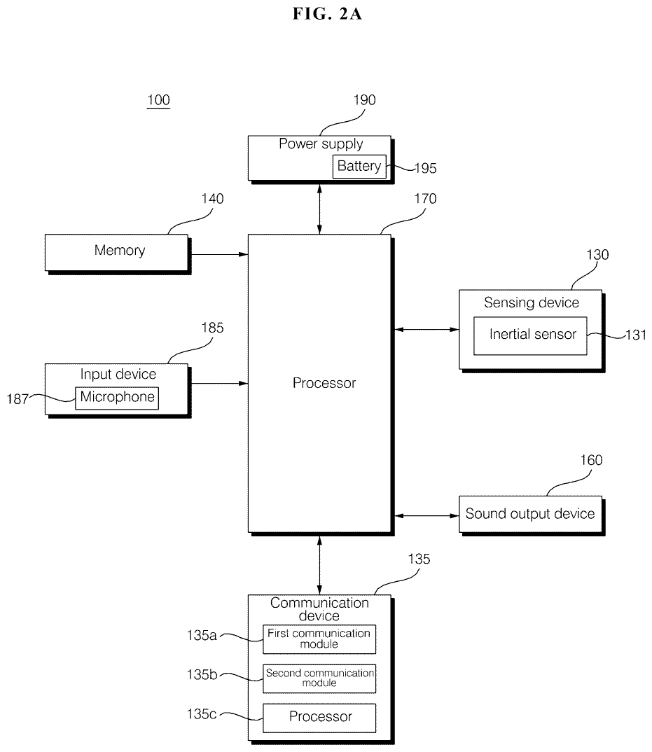

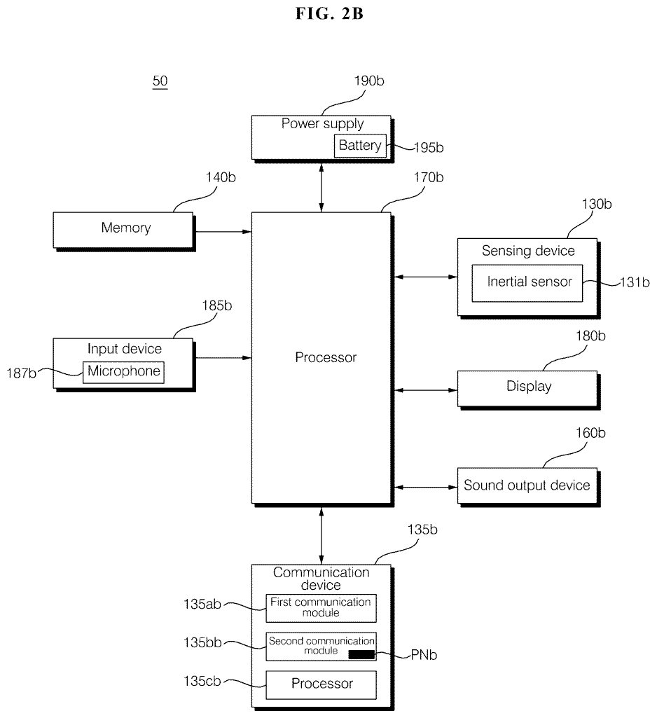

FIG. 2A is an example of an internal block diagram of the wireless audio receiving device of FIGS. 1A to 1E.

Referring to the figure, the wireless audio receiving device 100 may include a sensing device 130, a transceiver 135, a memory 140, a sound output device 160, a signal processing device 170, an input device 185, and a power supply 190. When these components are implemented in actual applications, if necessary, two or more components may be combined into one component, or one component may be subdivided into two or more components.

The sensing device 130 may include an inertial sensor 131. The inertial sensor may include an acceleration sensor, a gyro sensor, a gravity sensor, or the like. For example, the acceleration sensor, the gyro sensor, the gravity sensor, or the like may include a 6-axis sensor.

The sensing device 130 may be configured to output motion information of the wireless audio receiving device 100, for example, movement information (acceleration information, angular velocity information) or location information based on x, y, z axis.

Meanwhile, the sensing device 130 may include a sensor for obtaining user body information. For example, a blood pressure sensor, a brain wave sensor, or the like may be provided.

Meanwhile, the transceiver 135 may provide an interface for communication with an external device. To this end, the transceiver 135 may include at least one of a mobile communication module (not shown), a wireless Internet module (not shown), a short-distance communication module (not shown), or a GPS module (not shown).

For example, the transceiver 135 may be configured to perform IR communication, Bluetooth communication, or WiFi communication, thereby exchanging data with a paired wireless audio transmitting device 50 or transmitting data. In particular, it may be configured to receive an audio signal from the paired wireless audio transmitting device 50.

Meanwhile, the transceiver 135 may include a first communication module 135a that wirelessly receives a first audio signal according to the first communication standard of a first frequency band, and a second communication module 135b that wirelessly receives a second audio signal according to the second communication standard of a second frequency band greater than the first frequency band.

Meanwhile, the transceiver 135 may further include a processor 135c for signal processing or control of the first communication module 135a and the second communication module 135b.

Meanwhile, the first communication module 135a receives a first signal data through a first channel CH1, and separately receives a first audio data through a second channel CH2, and the second communication module 135b separately receives a second signal data and a second audio data through the same channel CHm.

Accordingly, even though the wireless environment is complex, it is possible to stably receive audio wirelessly and output sound. In addition, signal data and audio data can be distinguished in the first communication module 135a and the second communication module 135b, so that audio can be stably received wirelessly and sound can be output.

Meanwhile, the beacon signal received by the second communication module 135b may include unicast information or broadcast information. Accordingly, it is possible to operate by dividing into unicast and broadcast.

Meanwhile, in response to unicast information being included in the received beacon signal, the second communication module 135b may be configured to transmit association request information to the wireless audio transmitting device 50 or 100, and may be configured to receive association response information from the wireless audio transmitting device 50 or 100. Accordingly, it is possible to operate by dividing into unicast and broadcast.

Meanwhile, the second communication module 135b may distinguish whether it is the second signal data or the second audio data, based on identification information in the header among the received second audio signal. Accordingly, signal data and audio data can be distinguished, thereby stably receiving audio wirelessly and configured to output sound.

Meanwhile, the second communication module 135b may distinguish whether it is the second signal data or the second audio data, based on identification information in a media access control (MAC) header or a physical (PHY) header among the received second audio signal. Accordingly, signal data and audio data can be distinguished, thereby stably receiving audio wirelessly and configured to output sound.

Meanwhile, in response to receiving the second signal data, the second communication module 135b may extract encoding or decoding information of the second standard, and based on the extracted encoding or decoding information, may be configured to receive the second audio data after the second signal data, and may set a replay time of the second audio data. Accordingly, signal data and audio data can be distinguished, thereby stably receiving audio wirelessly and configured to output sound.

The memory 140 may store programs for processing or controlling the signal processing device 170 in the wireless audio receiving device 100, or may be configured to perform a function for temporarily storing input or output data.

The sound output device 160 may be configured to output an audio signal processed by the signal processing device 170 in the wireless audio receiving device 100.

Alternatively, the sound output device 160 may be configured to output guide information related to the operation of the wireless audio receiving device 100 as an audio signal.

Meanwhile, the sound output device 160 may be configured to output a first sound corresponding to the first audio signal from the first communication module 135a or a second sound corresponding to the second audio signal from the second communication module 135b.

The signal processing device 170 may control the overall operation of the wireless audio receiving device 100 by controlling the operation of each unit in the wireless audio receiving device 100.

Meanwhile, the signal processing device 170 may be configured to perform signal processing for an audio signal received from the outside.

Meanwhile, the signal processing device 170 may replay an audio signal from the first communication module 135a or the second communication module 135b.

Meanwhile, the signal processing device 170 may replay the second audio data, based on the decoding information from the second communication module 135b and a set replay time. Accordingly, signal data and audio data can be distinguished, thereby stably receiving audio wirelessly and configured to output sound.

Meanwhile, the input device 185 may include a button for initializing the wireless audio receiving device 100, or inputting an operation.

Meanwhile, the input device 185 may include a microphone 187 for sound collection.

Meanwhile, the input device 185 may include a camera (not shown) for capturing images.

For example, as shown in FIG. 2A, the input device 185 may include, in the drawing, a power key 185a for turning power on or off, a FF/REW key 185b for going forward or backward in the reproducing audio, a volume key 185c for volume up or down, a pause/play key 185d for playing or pausing audio, and the like.

The power supply 190 may supply power required for operation of each component under the control of the signal processing device 170.

In particular, the power supply 190 may include a battery 195 that stores and outputs DC power.

FIG. 2B is an example of an internal block diagram of the wireless audio transmitting device of FIGS. 1A to 1E.

Referring to the figure, the wireless audio transmitting device 50 may include a sensing device 130b, a transceiver 135b, a memory 140b, a sound output device 160b, a processor 170b, a display 180b, an input device 185b, and a power supply 190b. When these components are implemented in actual applications, if necessary, two or more components may be combined into one component, or one component may be subdivided into two or more components.

The sensing device 130b may include an inertial sensor 131b. The inertial sensor may include an acceleration sensor, a gyro sensor, a gravity sensor, or the like. For example, the acceleration sensor, the gyro sensor, the gravity sensor, or the like may include a 6-axis sensor.

The sensing device 130b may be configured to output motion information of the wireless audio transmitting device 50, for example, movement information (acceleration information, angular velocity information) or location information based on x, y, z axis.

Meanwhile, the sensing device 130b may include a sensor for obtaining user body information. For example, a blood pressure sensor, a brain wave sensor, or the like may be provided.

Meanwhile, the transceiver 135b may provide an interface for communication with an external device. To this end, the transceiver 135b may include at least one of a mobile communication module (not shown), a wireless Internet module (not shown), a short-distance communication module (not shown), or a GPS module (not shown).

For example, the transceiver 135b may be configured to perform IR communication, Bluetooth communication, or WiFi communication, thereby exchanging data with a paired wireless audio receiving device 100 or transmitting data. In particular, it may be configured to transmit an audio signal to the paired wireless audio receiving device 100.

Meanwhile, the transceiver 135b may include a first communication module 135ab that wirelessly transmits a first audio signal according to the first communication standard of a first frequency band, and a second communication module 135bb that wirelessly transmits a second audio signal according to the second communication standard of a second frequency band greater than the first frequency band.

Meanwhile, the second communication module 135bb may include a Personal Area Network (PAN) coordinator PNb for ultra-wideband communication.

Meanwhile, the transceiver 135b may further include a processor 135cb for signal processing or control of the first communication module 135ab and the second communication module 135bb.

Meanwhile, the first communication module 135ab transmits a first signal data through a first channel CH1 and separately transmits a first audio data through a second channel CH2, and the second communication module 135bb separately transmits a second signal data and a second audio data through the same channel CHm.

Accordingly, even though the wireless environment is complex, it is possible to stably transmit audio signals wirelessly. In addition, signal data and audio data may be distinguished in the first communication module 135ab and the second communication module 135bb, so that audio may be stably transmitted wirelessly.

Meanwhile, the beacon signal transmitted from the second communication module 135bb may include unicast information or broadcast information. Accordingly, it is possible to operate by dividing into unicast and broadcast.

Meanwhile, in response to unicast information being included in the transmitted beacon signal, the second communication module 135bb may be configured to receive association request information from the wireless audio receiving device 100 and may be configured to transmit association response information to the wireless audio receiving device 50 or 100. Accordingly, it is possible to operate by dividing into unicast and broadcast.

Meanwhile, the second communication module 135bb may distinguish whether it is the second signal data or the second audio data, based on identification information in the header among the received second audio signal. Accordingly, signal data and audio data can be distinguished, thereby stably receiving audio wirelessly and configured to output sound.

Meanwhile, the second communication module 135bb may distinguish whether it is the second signal data or the second audio data, based on identification information in a media access control (MACb) header or a physical (PHYb) header among the transmitted second audio signal. Accordingly, signal data and audio data may be distinguished, and thus, audio signals may be transmitted wirelessly in a stable manner.

The memory 140b may store programs for processing or controlling the processor 170b in the wireless audio transmitting device 50 or may be configured to perform a function for temporarily storing input or output data.

The sound output device 160b may be configured to output an audio signal processed by the processor 170b in the wireless audio transmitting device 50.

Alternatively, the sound output device 160b may be configured to output guide information related to the operation of the wireless audio transmitting device 100 as an audio signal.

The processor 170b may control the overall operation of the wireless audio transmitting device 50 by controlling the operation of each unit in the wireless audio transmitting device 50.

Meanwhile, the processor 170b may be configured to perform signal processing for an audio signal received from the outside.

Meanwhile, the processor 170b may control the operation of each unit based on data from the first communication module 135ab or the second communication module 135bb.

The display 180b may include LDC, OLED, LED, or micro LED.

Meanwhile, the input device 185b may include a button for initializing the wireless audio transmitting device 50 or inputting an operation.

Meanwhile, the input device 185b may include a microphone 187b for sound collection.

Meanwhile, the input device 185b may include a camera (not shown) for capturing images.

For example, as shown in FIG. 2B, the input device 185b may include, in the drawing, a power key 185ab for turning power on or off, a FF/REW key 185bb for going forward or backward in the reproducing audio, a volume key 185cb for volume up or down, a pause/play key 185db for playing or pausing audio, and the like.

The power supply 190b may supply power required for operation of each component under the control of the processor 170b.

In particular, the power supply 190b may include a battery 195b that stores and outputs DC power.

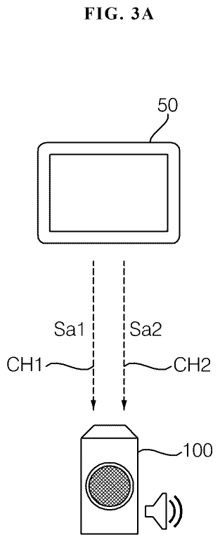

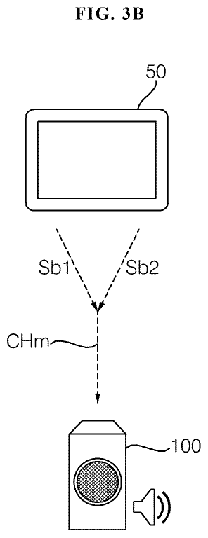

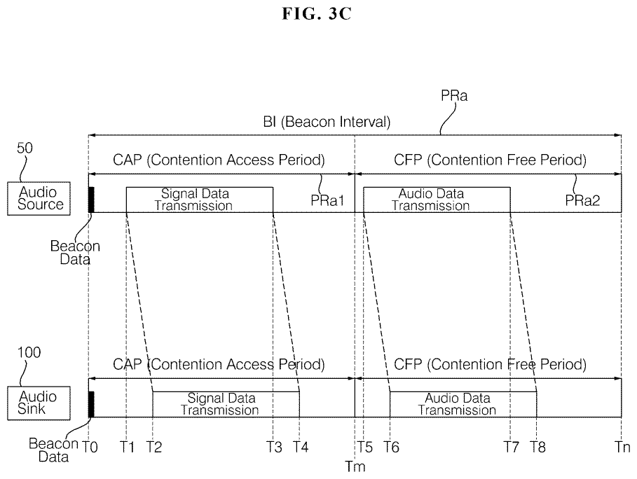

FIGS. 3A to 8B are diagrams for explaining an operation of a wireless audio receiving device or a wireless audio transmitting device according to an embodiment of the present disclosure.

FIG. 3A illustrates that the wireless audio transmitting device 50 output a first signal data Sa1 and a first audio data Sa2 to the wireless audio receiving device 100.

Referring to FIG. 3A, the wireless audio transmitting device 50 wirelessly outputs the first signal data Sa1 and the first audio data Sa2 according to the first communication standard of a first frequency band.

In particular, the wireless audio transmitting device 50 may be configured to transmit the first signal data Sa1 through the first channel CH1, and separately transmit the first audio data Sa2 through the second channel CH2.

Accordingly, the first communication module 135a in the wireless audio receiving device 100 according to an embodiment of the present disclosure receives the first signal data Sa1 through the first channel CH1, and distinguishes and receives the first audio data Sa2 through the second channel CH2.

FIG. 3B illustrates that the wireless audio transmitting device 50 outputs the second signal data Sb1 and the second audio data Sb2 to the wireless audio receiving device 100.

Referring to FIG. 3B, the wireless audio transmitting device 50 wirelessly outputs the second signal data Sb1 and the second audio data Sb2 according to the second communication standard of a second frequency band greater than the first frequency band.

In particular, the wireless audio transmitting device 50 may separately transmit the second signal data Sb1 and the second audio data Sb2 through the same channel CHm.

Accordingly, the second communication module 135b in the wireless audio receiving device 100 according to an embodiment of the present disclosure separately receives the second signal data Sb1 and the second audio data Sb2 through the same channel CHm.

Meanwhile, the first communication standard may be a Bluetooth communication standard, and the second communication standard may be an ultra-wideband (UWB) communication standard.

For example, the wireless audio transmitting device 50 may wirelessly transmit an audio signal according to the first communication standard, and then wirelessly transmit the audio signal according to the second communication standard when the wireless environment is complex.

Accordingly, the wireless audio receiving device 100 may stably receive audio wirelessly and output sound even though the wireless environment is complex. In addition, signal data and audio data can be distinguished in the first communication module 135a and the second communication module 135b, so that audio can be stably received wirelessly and sound can be output.

Meanwhile, according to an embodiment of the present disclosure, the first communication module 135a may separately transmit first signal data Sa1 through the first channel CH1 and first audio data Sa2 through the second channel CH2, and the second communication module 135b may be configured to transmit second signal data Sb1 and second audio data Sb2 separately through the same channel CHm. Accordingly, even though the wireless environment is complex, it is possible to stably receive audio wirelessly and output sound. Also, signal data and audio data may be transmitted separately.

Meanwhile, the beacon signal transmitted from the second communication module 135b in the wireless audio transmitting device 50 may include unicast information or broadcast information. Accordingly, it is possible to operate by dividing into unicast and broadcast.

Meanwhile, in response to unicast information being included in the transmitted beacon signal, the second communication module 135b within the wireless audio transmitting device 50 may be configured to receive association request information from the wireless audio receiving device 100 and may be configured to transmit association response information from an electronic device to the wireless audio receiving device 100. Accordingly, it is possible to operate by dividing into unicast and broadcast. Also, the second communication module 135b may check whether ultra-wideband (UWB) wireless audio support is available and transmit audio data wirelessly.

Meanwhile, the second communication module 135b in the wireless audio transmitting device 50 may add identification information in a media access control (MAC) header or a physical (PHY) header in order to distinguish whether the transmitted second audio signal is the second signal data Sb1 or the second audio data Sb2. Accordingly, it is possible to operate by dividing into unicast and broadcast.

Meanwhile, when the first communication module 135a in the wireless audio transmitting device 50 is configured to transmit the first audio signal and then the second communication module 135b is configured to transmit the second audio signal, Host Control Interface (HCI) data of the first communication standard may be mapped to MAC Layer Management Entity (MLME) interface of the second communication standard, and Asynchronous Connection-Less (ACL) data and audio data of the first communication standard may be mapped to a MAC Common Part Sublayer (MCPS) interface of the second communication standard. Accordingly, signal data and audio data can be distinguished, thereby stably transmitting audio wirelessly.

Meanwhile, when the first communication module 135a in the wireless audio transmitting device 50 is configured to transmit the first audio signal and then the second communication module 135b is configured to transmit the second audio signal, an adaptation layer (AL) may be used to map data of the first communication standard to data of the second communication standard. Accordingly, signal data and audio data can be distinguished, thereby stably transmitting audio wirelessly.

Meanwhile, when the second communication module 135b in the wireless audio transmitting device 50 is configured to transmit the second audio signal, it may be configured to transmit the second signal data Sb1 in a contention access period (CAP) of the beacon interval PRa, and may be configured to transmit the second audio data Sb2 in a contention free period (CFP) of the beacon interval PRa. Accordingly, signal data and audio data can be distinguished, thereby stably transmitting audio wirelessly.

Meanwhile, the first communication module 135a in the wireless audio transmitting device 50 may be configured to transmit the first signal data Sa1 and transmit identification information in the first signal data Sa1 to the second communication module 135b, and the second communication module 135b may separately transmit the second signal data Sb1 in the second audio signal, based on the identification information from the first communication module 135a. Accordingly, signal data and audio data can be distinguished, thereby stably transmitting audio wirelessly.

Meanwhile, the first communication module 135a in the wireless audio transmitting device 50 may be configured to transmit the first audio data Sa2 and transmit identification information in the first audio data Sa2 to the second communication module 135b, and the second communication module 135b may separately transmit the second audio data Sb2 in the second audio signal, based on the identification information from the first communication module 135a. Accordingly, signal data and audio data can be distinguished, thereby stably transmitting audio wirelessly.

Meanwhile, the second communication module 135b in the wireless audio transmitting device 50 may be configured to receive a security activation value from the wireless audio receiving device 100, and if it matches, generate a key, and encrypt and transmit the second audio data Sb2 by using the generated key. Accordingly, it is possible to stably transmit audio wirelessly based on security.

FIG. 3c is a diagram for explaining the operation of the wireless audio transmitting device 50 and the first communication module 135a of the wireless audio receiving device 100.

Referring to FIG. 3, the wireless audio transmitting device 50 may wirelessly transmit beacon data at time To during the beacon interval PRa, and the wireless audio receiving device 100 may wirelessly receive the beacon data.

Meanwhile, the wireless audio transmitting device 50 may be configured to transmit signal data in a contention access period (CAP) of the beacon interval PRa, and transmit audio data in a contention free period (CFP) of the beacon interval PRa.

In particular, FIG. 3 illustrates that signal data is transmitted between time T1 and time T3 within a contention access period (CAP), and audio data is transmitted between time T5 and time T7 within a contention free period (CFP).

In response, the wireless audio receiving device 100 may be configured to receive signal data between time T2 and time T4 within a contention access period (CAP), and may be configured to receive audio data between time T6 and time T8 within a contention free period (CFP).

That is, when the second communication module 135b in the wireless audio receiving device 100 receives the second audio signal, it may be configured to receive the second signal data Sb1 in the contention access period (CAP) of the beacon interval PRa, and may be configured to receive the second audio data Sb2 in the contention free period (CFP) of the beacon interval PRa. Accordingly, signal data and audio data can be distinguished, thereby stably receiving audio wirelessly and configured to output sound.

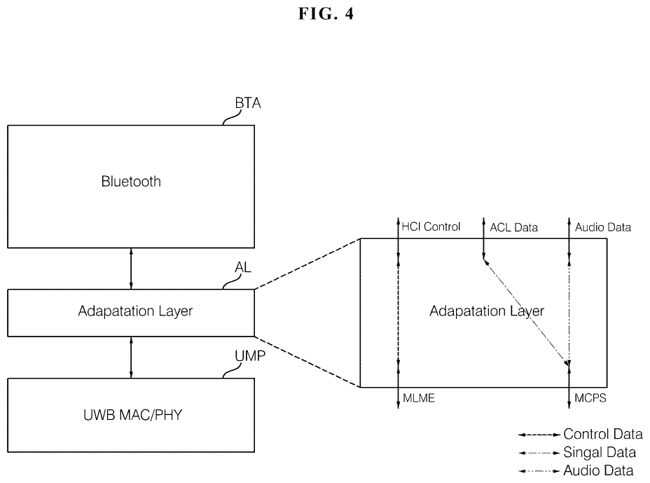

FIG. 4 is a diagram for explaining mapping between the first communication standard and the second communication standard.

Referring to FIG. 4, in order to provide a UWB audio service which is an example of the second communication standard, Bluetooth audio, which is an example of the first communication standard optimized for the audio service, is adopted as an upper protocol.

Bluetooth audio (BTA) interface is composed of HCI Control, ACL Data, and Audio Data.

Meanwhile, the Media access control or physical layer (MAC/PHY) (UMP) of UWB may have a MAC Layer Management Entity (MLME) interface and a MAC Common Part Sublayer (MCPS) interface.

Meanwhile, for mapping between Bluetooth audio (BTA) and UWB media access control or a physical layer (MAC/PHY) (UMP), an adaptation layer (AL) is utilized in an embodiment of the present disclosure.

In the adaptation layer (AL), Host Control Interface (HCI) data of the first communication standard may be mapped to MAC Layer Management Entity (MLME) interface of the second communication standard, and Asynchronous Connection-Less (ACL) data and audio data of the first communication standard may be mapped to a MAC Common Part Sublayer (MCPS) interface of the second communication standard.

Meanwhile, UWB wireless transmission or UWB wireless reception has a frequency band 3.1 GHz to 10.6 GHz different from the unlicensed band 2.4 GHz, thereby avoiding frequency interference with other wireless devices using the unlicensed band, and solving problems such as audio interruption.

In addition, since UWB wireless transmission or UWB wireless reception provides a higher PHY data rate than Bluetooth wireless transmission or wireless reception, high-quality audio service is possible.

Meanwhile, when the first communication module 135a receives the first audio signal and then the second communication module 135b receives the second audio signal, Host Control Interface (HCI) data of the first communication standard may be mapped to the MAC Layer Management Entity (MLME) interface of the second communication standard, and Asynchronous Connection-Less (ACL) data and audio data of the first communication standard may be mapped to the MAC Common Part Sublayer (MCPS) interface of the second communication standard. Accordingly, signal data and audio data can be distinguished, thereby stably receiving audio wirelessly and configured to output sound.

Meanwhile, when the first communication module 135a receives the first audio signal and then the second communication module 135b receives the second audio signal, data of the first communication standard may be mapped to data of the second communication standard by using an adaptation layer AL. Accordingly, signal data and audio data can be distinguished, thereby stably receiving audio wirelessly and configured to output sound.

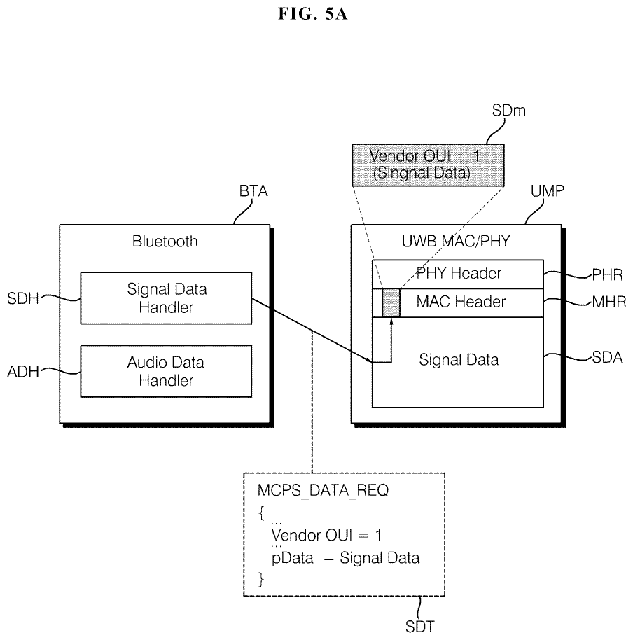

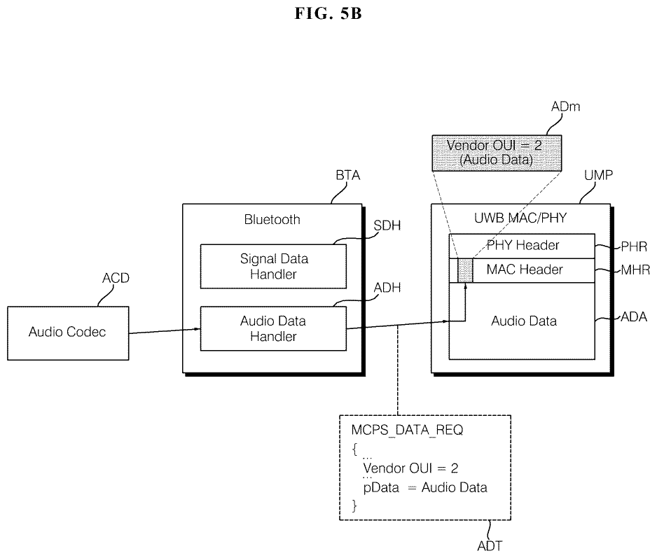

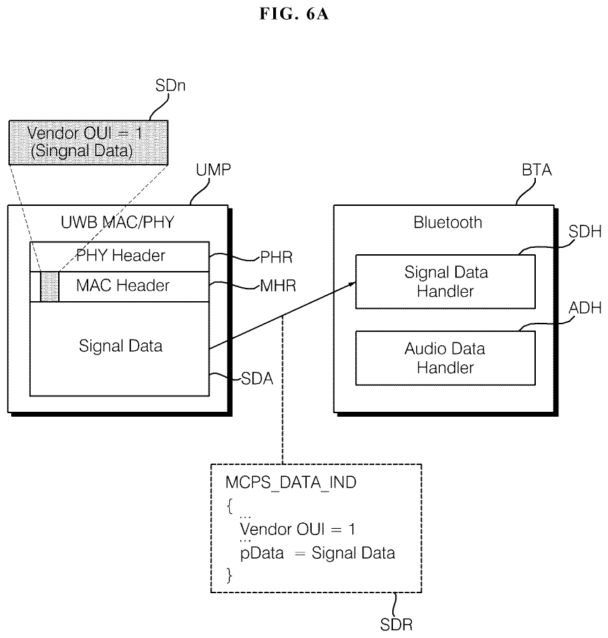

FIGS. 5A and 5B are diagrams for explaining an operation of a wireless audio transmitting device.

Referring to the drawing, the signal data handler SDH in the Bluetooth audio BTA of the wireless audio transmitting device 50 may define an identifier for distinguishing between signal data and audio data by using the Vendor OUI Field of the UWB MAC Header.

FIG. 5A illustrates signal data SDT when the Vendor OUI is ‘1’, and FIG. 5b illustrates audio data ADT when the Vendor OUI is ‘2’.

In particular, the Bluetooth audio BTA of the wireless audio transmitting device 50 may be configured to transmit signal data SDT for codec and QoS configuration used in the UWB audio service.

Meanwhile, when the wireless audio transmitting device 50 is configured to transmit the signal data SDT to the Media access control or physical layer (MAC/PHY) (UMP) of UWB, Vendor OUI, which is UWB MAC Header, may be set to ‘1’ and transmitted.

Meanwhile, in the wireless audio receiving device 100, when codec and QoS configuration are completed, audio data may be transmitted from the audio codec to Bluetooth audio BTA, and Bluetooth Audio BTA may be transmitted to the Media access control or physical layer (MAC/PHY) (UMP) of UWB by setting the Vendor OUI, which is UWB MAC Header, to ‘2’.

In addition, the wireless audio transmitting device 50 may be configured to transmit audio data to the wireless audio receiving device 100 with respect to Media access control or physical layer (MAC/PHY) (UMP) of UWB. Accordingly, even though the wireless environment is complex, it is possible to stably receive audio wirelessly and output sound.

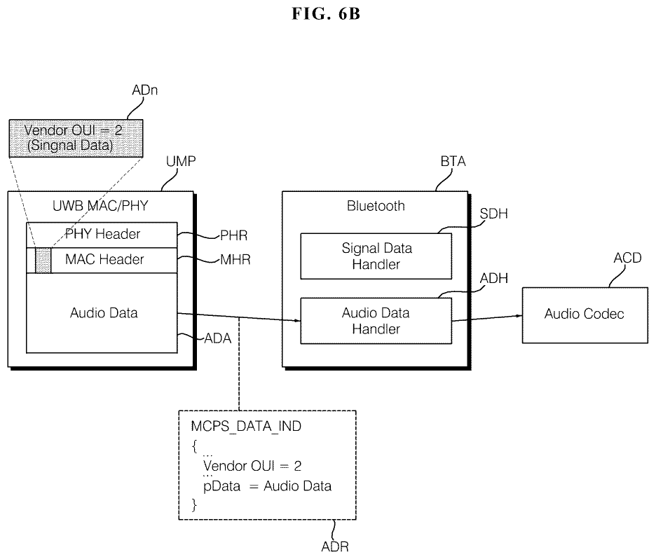

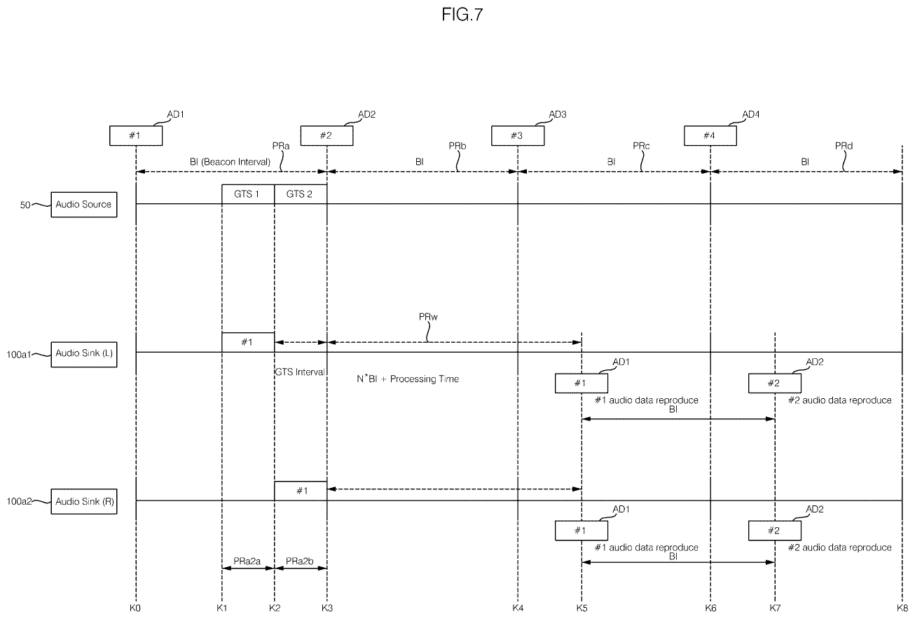

FIGS. 6A and 6B are diagrams for explaining an operation of a wireless audio receiving device.

Referring to the drawing, an identifier for distinguishing between signal data and audio data of Bluetooth audio (BTA) may be defined through the MCPS interface of the wireless audio receiving device 100.

FIG. 6A illustrates signal data SDR when the Vendor OUI is ‘1’, and FIG. 6b illustrates audio data ADR when the Vendor OUI is ‘2’.

When the Media access control or physical layer (MAC/PHY) (UMP) of UWB of the wireless audio receiving device 100 receives data having Vendor OUI, which is the UWB MAC Header, that is set to ‘1’, Bluetooth audio BTA may move to the signal data handler SDH.

In particular, the Bluetooth audio BTA of the wireless audio receiving device 100 may be configured to receive codec and QoS information used in the UWB audio service through a signal data handler SDH, and set information necessary for audio data reception.

Meanwhile, when the codec and QoS configuration for UWB audio service are completed, data whose Vendor OUI, which is the UWB MAC Header, is ‘2’ is received, and Bluetooth audio BTA may move to the audio data handler ADH.

The Bluetooth audio BTA sets a reproducing time for audio data received through an audio data handler (ADH), and the audio data having set reproducing time is transmitted to an audio codec. Accordingly, even though the wireless environment is complex, it is possible to stably receive audio wirelessly and output sound.

FIG. 7 is a diagram for explaining an UWB audio reproducing time synchronization.

Referring to FIG. 7, the wireless audio transmitting device 50 may sequentially transmit first to fourth audio data AD1 to AD4 to a plurality of wireless audio receiving devices 100a1 and 100a2 respectively.

In particular, the wireless audio transmitting device 50 may sequentially transmit the first to fourth audio data AD1 to AD4 for each channel in a beacon interval.

FIG. 7 illustrates that a first audio data AD1 is generated at time K0, transmitted to a first wireless audio receiving device 100a1 in an interval PRa2a between time K1 and time K2, and transmitted to a second wireless audio receiving device 100a2 in an interval PRa2b between time K2 and time K3.

Meanwhile, the interval PRa2a and the interval PRa2b may be set respectively by a plurality of wireless audio receiving devices 100a1 and 100a2 that receive audio data.

Similarly, at time K3, a second audio data AD2 is generated, and transmitted to the first wireless audio receiving device 100a1 and the second wireless audio receiving device 100a2, within a second beacon interval PRb.

Similarly, at time K4, a third audio data AD3 is generated, and transmitted to the first wireless audio receiving device 100a1 and the second wireless audio receiving device 100a2, within a third beacon interval PRc.

Similarly, at time K6, a fourth audio data AD4 is generated, and transmitted to the first wireless audio receiving device 100a1 and the second wireless audio receiving device 100a2, within a fourth beacon interval PRd.

Meanwhile, in order to synchronize and reproduce the first audio data AD1 received in a first beacon interval PRa in the plurality of wireless audio receiving devices 100a1 and 100a2, it is preferable that it is not reproduced in a second beacon interval PRb, but reproduced at the time K5 in the third beacon interval PRc.

That is, after audio data is reproduced, it is preferable that it is reproduced not in the next beacon interval but in the beacon interval after next.

Meanwhile, it is preferable that the interval PRw from the audio data reception completion time K3 to the reproducing start point K5 is greater than the length of the beacon interval. Accordingly, it is possible to stably synchronize and reproduce audio data.

Meanwhile, after the first audio data AD1 is reproduced at the time K5, it is preferable that the second audio data AD2 is spaced apart by the beacon interval and reproduced at the time K7. Accordingly, it is possible to stably synchronize and reproduce audio data.

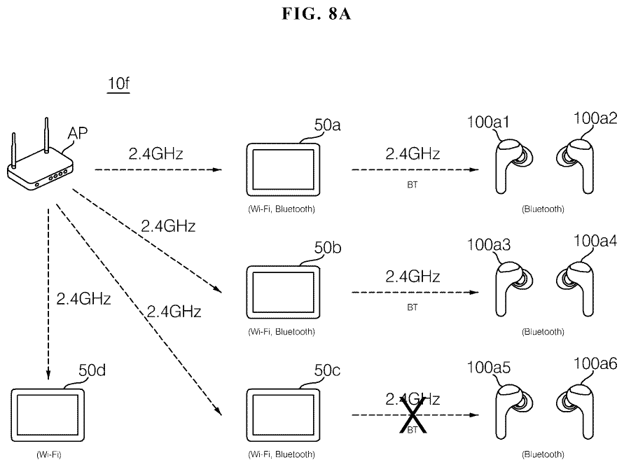

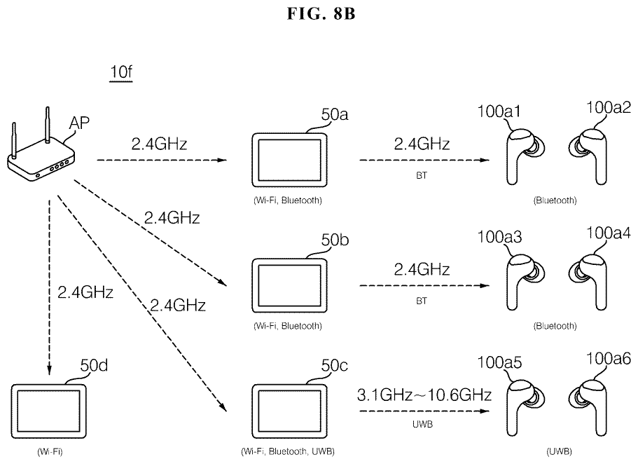

FIGS. 8A and 8b illustrate a wireless audio system 10f including an AP device (AP), a plurality of wireless audio transmitting devices 50a to 50d, and a plurality of wireless audio receiving devices 100a1 to 100a6.

As shown in FIG. 8A, in a complicated wireless environment, between the plurality of wireless audio transmitting devices 50a to 50d and the plurality of wireless audio receiving devices 100a1 to 100a6, when audio is transmitted wirelessly by using Bluetooth communication which is the same first communication standard, audio data transmission becomes impossible due to frequency interference.

FIG. 8A illustrates that audio data transmission is impossible due to frequency interference, between a third wireless audio transmitting device 50c and the plurality of wireless audio receiving devices 100a5 to 100a6.

In order to solve this problem, an embodiment of the present disclosure utilizes the second communication standard having a larger frequency band and a larger bandwidth than the first communication standard. The second communication standard may be UWB.

As shown in FIG. 8B, in a complicated wireless environment, it is preferable that among a plurality of wireless audio transmitting devices 50a to 50d and a plurality of wireless audio receiving devices 100a1 to 100a6, devices excluding the third wireless audio transmitting device 50c and the plurality of wireless audio receiving devices 100a5 to 100a6 use Bluetooth communication which is the first communication standard, and the third wireless audio transmitting device 50c and the plurality of wireless audio receiving devices 100a5 to 100a6 use UWB communication. Accordingly, it is possible to stably transmit and receive wireless audio data even in a complicated wireless environment.

Meanwhile, ultra-wideband (UWB) communication, with its low frequency congestion and strong resistance to interference, may be suitable for use in complex wireless environments.

Accordingly, while UWB communication is typically used for indoor positioning, the present disclosure assumes that UWB communication is utilized for audio services.

Meanwhile, although UWB communication is provided under standard specifications such as the IEEE 802.15.4, no method for frequency hopping based on UWB communication has been provided; accordingly, the present disclosure provides a method for performing frequency hopping in ultra-wideband communication using beacon signals.

Meanwhile, ultra-wideband communication may be performed without being affected by physical interference if either the channel or the preamble code is different from the others.

For example, available frequency bands may be logically divided, and each section may be identified as channel 1, channel 2, and so on.

Meanwhile, a preamble code refers to a code used when configuring a physical signal.

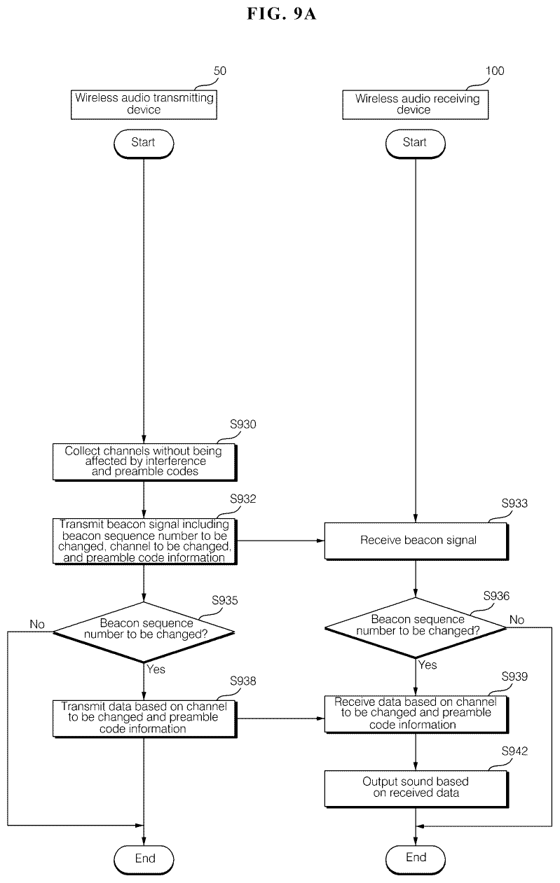

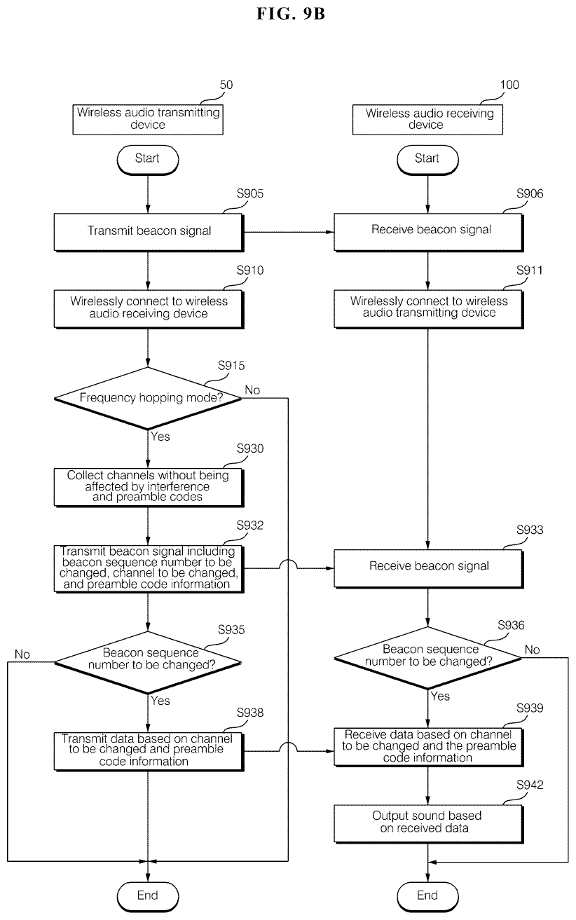

Accordingly, the present disclosure may define the concept of frequency hopping not only as changing the frequency band but also as changing a channel or a preamble code related to the frequency band. Frequency hopping according to the present disclosure will be described with reference to FIG. 9A and the following figures.

FIG. 9A is an example of a flowchart showing a method of operating a wireless audio output system according to an embodiment of the present disclosure.

Referring to the figure, in the frequency hopping mode, the transceiver 135b within the wireless audio transmitting device 50 of the wireless audio output system 10 according to an embodiment of the present disclosure performs a scan for all channels and the entire preamble code information based on ultra-wideband communication.

Then, the transceiver 135b within the wireless audio transmitting device 50 collects channels without being affected by interference and preamble codes S930.

In other words, the transceiver 135b within the wireless audio transmitting device 50 collects idle channels and preamble code information.

Then, the transceiver 135b within the wireless audio transmitting device 50 may generate a candidate list for frequency hopping including the collected idle channels and preamble code information.

Then, in the frequency hopping mode, the transceiver 135b within the wireless audio transmitting device 50 wirelessly transmits a first beacon signal including a beacon sequence number to be changed, a channel to be changed, or preamble code information using the idle channel or preamble code information within the candidate list S932.

In response to the operation above, the transceiver 135 within the wireless audio receiving device 100 of the wireless audio output system 10 receives the first beacon signal including the beacon sequence number to be changed, the channel to be changed, or preamble code information S933.

Next, when a second beacon signal corresponding to the beacon sequence number to be changed in the first beacon signal output in the S932 step is output among periodically transmitted beacon signals S935, the transceiver 135b within the wireless audio transmitting device 50 transmit a wireless audio signal to the wireless audio receiving device 100 based on the channel to be changed or the preamble code information S938.

In other words, in response to the second beacon signal output after the first beacon signal corresponding to the beacon sequence number to be changed S935, the transceiver 135b within the wireless audio transmitting device 50 transmit a wireless audio signal to the wireless audio receiving device 100 based on the channel to be changed or the preamble code information.

In response to the operation above, in response to the second beacon signal received after the first beacon signal corresponding to the beacon sequence number to be changed S936, the transceiver 135 within the wireless audio receiving device 100 receives a wireless audio signal based on the channel to be changed or the preamble code information S939, and the sound output device 160 outputs sound corresponding to the received wireless audio signal S942.

Accordingly, frequency hopping may be performed in ultra-wideband communication using beacon signals. Since channel and preamble code information are utilized, frequency hopping may be performed in ultra-wideband communication while interference is avoided efficiently. Also, audio services based on ultra-wideband communication may be performed stably.

Meanwhile, according to FIG. 9A, before the ultra-wideband wireless connection between the wireless audio transmitting device 50 and the wireless audio receiving device 100, the transceiver 135b within the wireless audio transmitting device 50 may be configured to transmit the first beacon signal including the beacon sequence number to be changed, the channel to be changed, or preamble code information.

In particular, the transceiver 135b within the wireless audio transmitting device 50 may be configured to output the first beacon signal further including current channel information and current preamble code information in addition to the beacon sequence number to be changed, the channel to be changed, or the preamble code information.

The transceiver 135b within the wireless audio transmitting device 50 may connect to the wireless audio receiving device 100 based on a connection request command received from the wireless audio receiving device 100 after the first beacon signal is output.

In other words, the transceiver 135 within the wireless audio receiving device 100 may be configured to receive the first beacon signal further including the current channel information and the current preamble code information in addition to the beacon sequence number to be changed, the channel to be changed, or the preamble code information before the wireless connection between the wireless audio transmitting device 50 and the wireless audio receiving device 100.

The transceiver 135 within the wireless audio receiving device 100 may be configured to transmit the connection request command to the wireless audio transmitting device 50 based on the first beacon signal, establish a connection with the wireless audio transmitting device 50 based on the connection request command, and, after connecting to the wireless audio transmitting device 50, receive a wireless audio signal based on the channel and preamble code information if the received second beacon signal corresponds to the beacon sequence number to be changed.

Meanwhile, after connecting to the wireless audio receiving device 100, the transceiver 135b within the wireless audio transmitting device 50 may be configured to transmit a wireless audio signal to the wireless audio receiving device 100 based on the channel and preamble code information in response to the output second beacon signal corresponding to the beacon sequence number to be changed. Accordingly, frequency hopping in ultra-wideband communication may be performed after the wireless connection using the beacon signal transmitted before the wireless connection.

Meanwhile, unlike the operation described in FIG. 9A, it is also possible for the ultra-wideband wireless connection between the wireless audio transmitting device 50 and the wireless audio receiving device 100 to be established before the S930 step. This alternative approach will be described with reference to FIG. 9B.

FIG. 9B is another example of a flowchart showing a method of operating a wireless audio output system according to an embodiment of the present disclosure.

Referring to the figure, the transceiver 135b within the wireless audio transmitting device 50 of the wireless audio output system 10 according to an embodiment of the present disclosure is configured to transmit a beacon signal S905.

At this time, the beacon signal may include current channel information and current preamble code information but may not include a beacon sequence number to be changed, a channel to be changed, or preamble code information.

In response to the operation above, the transceiver 135 within the wireless audio receiving device 100 of the wireless audio output system 10 is configured to receive the beacon signal S906.

The transceiver 135 within the wireless audio receiving device 100 is configured to transmit a connection request command to the wireless audio transmitting device 50 based on the received beacon signal.

In response to the operation above, the transceiver 135 within the wireless audio receiving device 100 is configured to perform an ultra-wideband-based wireless connection to the wireless audio receiving device 100 based on the connection request command S910.

Similarly, the transceiver 135 within the wireless audio receiving device 100 is configured to perform an ultra-wideband-based wireless connection to the wireless audio transmitting device 50 S911.

Next, the transceiver 135 within the wireless audio receiving device 100 is configured to enter the frequency hopping mode according to the setting or surrounding wireless environment S915 and, in the frequency hopping mode, perform scanning of all channels and the entire preamble code information based on ultra-wideband communication.

Then, the transceiver 135b within the wireless audio transmitting device 50 is configured to collect channels with no interference and preamble codes S930.

In other words, the transceiver 135b within the wireless audio transmitting device 50 is configured to collect channels in the idle state and preamble code information.

Then, the transceiver 135b within the wireless audio transmitting device 50 may be configured to generate a frequency hopping candidate list including the collected channels in the idle state and preamble code information.

Next, in the frequency hopping mode, the transceiver 135b within the wireless audio transmitting device 50 is configured to transmit a first beacon signal including a beacon sequence number to be changed, a channel to be changed, or preamble code information using the channels in the idle state or preamble code information in the candidate list S932.

In response to the operation above, the transceiver 135 within the wireless audio receiving device 100 of the wireless audio output system 10 is configured to receive the first beacon signal including the beacon sequence number to be changed, the channel to be changed, or the preamble code information S933.

Next, if the second beacon signal corresponding to the beacon sequence number to be changed included in the first beacon signal output in the S932 step is output among the periodically output beacon signals S935, the transceiver 135b within the wireless audio transmitting device 50 is configured to transmit a wireless audio signal to the wireless audio receiving device 100 based on the channel to be changed or the preamble code information S938.

In other words, in response to the second beacon signal output after the first beacon signal corresponding to the beacon sequence number to be changed S935, the transceiver 135b within the wireless audio transmitting device 50 is configured to transmit a wireless audio signal to the wireless audio receiving device 100 based on the channel to be changed or the preamble code information.

In response to the operation above, in response to the second beacon signal received after the first beacon signal corresponding to the beacon sequence number to be changed S936, the transceiver 135 within the wireless audio receiving device 100 is configured to receive the wireless audio signal based on the channel to be changed or the preamble code information S939, and the sound output device 160 is configured to output sound corresponding to the received wireless audio signal S942.

Accordingly, frequency hopping in ultra-wideband communication may be performed using beacon signals. Since channel and preamble code information are utilized, frequency hopping may be performed in ultra-wideband communication while interference is avoided efficiently. Also, audio services based on ultra-wideband communication may be performed stably.

Meanwhile, according to FIG. 9B, unlike FIG. 9A, the transceiver 135b within the wireless audio transmitting device 50 may be configured to transmit the first beacon signal after connecting to the wireless audio receiving device 100; in response to the second beacon signal output after the first beacon signal corresponding to the beacon sequence number to be changed, the wireless audio signal may be transmitted to the wireless audio receiving device 100 based on the channel to be changed or the preamble code information. Accordingly, frequency hopping may be performed in ultra-wideband communication using beacon signals.

In other words, the transceiver 135 within the wireless audio receiving device 100 may be configured to receive the first beacon signal further including current channel information and current preamble code information, transmit a connection request command to the wireless audio transmitting device 50 based on the first beacon signal, and connect to the wireless audio transmitting device 50 based on the connection request command; after connecting to the wireless audio transmitting device 50, if the second beacon signal received corresponds to the beacon sequence number to be changed, the transceiver 135 within the wireless audio receiving device 100 may be configured to receive a wireless audio signal based on the channel and preamble code information. Accordingly, frequency hopping may be performed in ultra-wideband communication using a beacon signal transmitted before wireless connection.

Meanwhile, for additional frequency hopping, the transceiver 135b within the wireless audio transmitting device 50 may be configured to add a beacon sequence number to be additionally changed, a channel to be additionally changed, or preamble code information to the second beacon signal based on the collected channel and preamble code information to output the second beacon signal including a beacon sequence number to be changed, the channel to be changed, or the preamble code information. Accordingly, frequency hopping may be performed in ultra-wideband communication using beacon signals.

In other words, the transceiver 135 within the wireless audio receiving device 100 may be configured to receive the first beacon signal after connecting to the wireless audio transmitting device 50 and, in response to the second beacon signal received after the first beacon signal corresponding to the beacon sequence number to be changed, receive the wireless audio signal based on the channel to be changed or the preamble code information. Accordingly, frequency hopping may be performed in ultra-wideband communication using beacon signals.

Alternatively, the transceiver 135b within the wireless audio transmitting device 50 may be configured to output a third beacon signal including a beacon sequence number to be additionally changed, a channel to be additionally changed, or preamble code information after the second beacon signal based on the collected channel and preamble code information. Accordingly, frequency hopping may be performed in ultra-wideband communication using beacon signals.

In other words, the transceiver 135 within the wireless audio receiving device 100 may be configured to establish a wireless connection with the second wireless audio transmitting device 50 upon receiving the third beacon signal including the current channel information, the current preamble code information, the beacon sequence number to be changed, the channel to be changed, or the preamble code information from the second wireless audio transmitting device 50. Accordingly, a wireless connection with the second wireless audio transmitting device 50 based on ultra-wideband communication may be established using beacon signals.

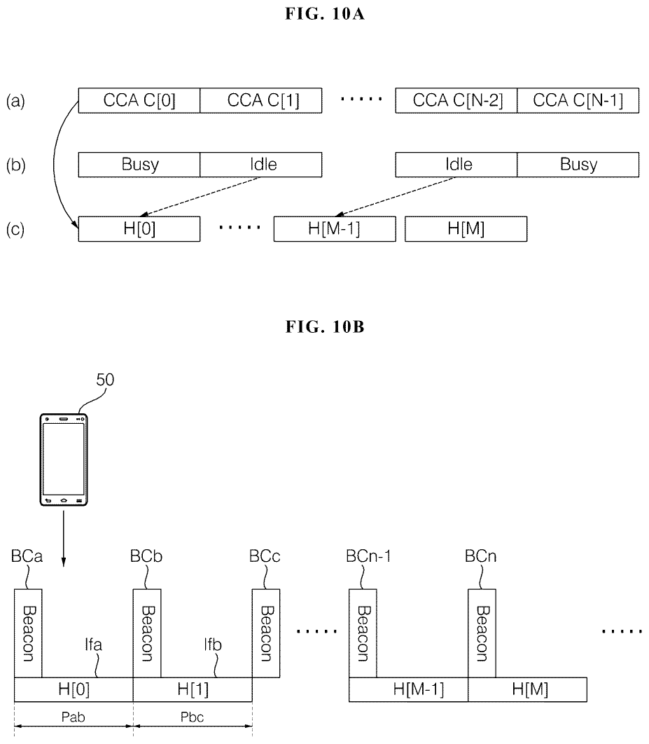

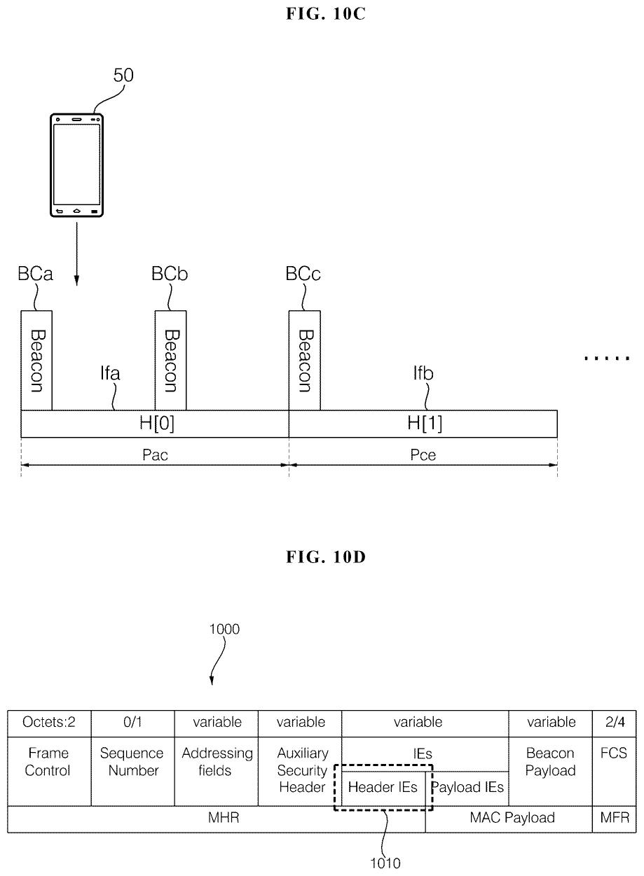

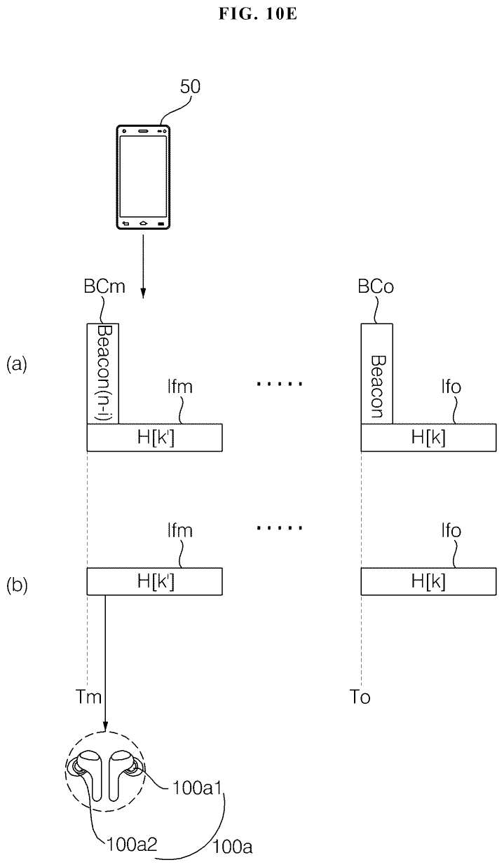

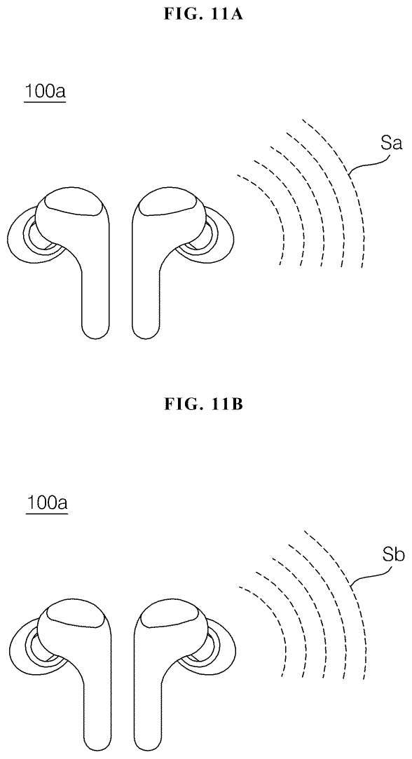

FIGS. 10A to 11B are diagrams referred to in description of FIG. 9A or FIG. 9B.

FIG. 10a(a) illustrates a case in which the PAN coordinator PNb within the transceiver 135b of the wireless audio transmitting device 50 is configured to perform scanning of all channels and the entire preamble code information.

Referring to the figure, preamble codes [0] to [N-1] may be assigned to channel CCA C.

Meanwhile, unlike the figure, the total number of channels may range from 1 to M, and for each channel, N preamble codes ranging from [0] to [N-1] may be assigned, resulting in a total of M×N combinations of channels and preamble codes.

After scanning all channels and the entire preamble code information, the PAN coordinator PNb within the transceiver 135b of the wireless audio transmitting device 50 may be configured to distinguish channels and preamble codes with no interference, as illustrated in FIG. 10a(b).

In other words, by performing scanning of all channels and the entire preamble code information, the PAN coordinator PNb within the transceiver 135b of the wireless audio transmitting device 50 may be configured to discard channels in the busy state and preamble code information and collect channels in the idle state and preamble code information.

Then, based on the collected channel and preamble code information, the PAN coordinator PNb within the transceiver 135b of the wireless audio transmitting device 50 may be configured to generate a frequency hopping candidate list including the collected channels in the idle state and preamble code information, as illustrated in FIG. 10a(c).

The PAN coordinator PNb within the transceiver 135b of the wireless audio transmitting device 50 may be configured to enable frequency hopping to be performed using the generated frequency hopping candidate list.

For example, in the frequency hopping mode, the PAN coordinator PNb within the transceiver 135b of the wireless audio transmitting device 50 may be configured to wirelessly transmit the first beacon signal including a beacon sequence number to be changed, a channel to be changed, or preamble code information using channels in the idle state or preamble code information from the candidate list.

Meanwhile, in response to the second beacon signal output after the first beacon signal corresponding to the beacon sequence number to be changed, the transceiver 135b of the wireless audio transmitting device 50 may be configured to transmit a wireless audio signal to the wireless audio receiving device 100 based on the channel to be changed or the preamble code information. Accordingly, frequency hopping in ultra-wideband communication may be performed using beacon signals.

For example, if the channel in the idle state or the preamble code information in the candidate list includes preamble code information [0] and [1] for channel 1, and preamble code information [1] and [2] for channel 3, the transceiver 135b of the wireless audio transmitting device 50 may be configured to transmit a wireless audio signal based on the preamble code information [0] of channel 1 at a first time point and then transmit the wireless audio signal based on the preamble code information [1] of channel 3 at a second time point corresponding to the beacon sequence number to be changed. In this way, frequency hopping may be performed using different channels and different preamble codes.

In another example, the transceiver 135b of the wireless audio transmitting device 50 may be configured to transmit a wireless audio signal based on the preamble code information [0] of channel 1 at the first time point and then transmit the wireless audio signal based on the preamble code information [1] of channel 1 at the second time point corresponding to the beacon sequence number to be changed. In this way, frequency hopping may be performed even when the same channel is used with different preamble codes.

FIG. 10B illustrates a case in which the frequency hopping interval is a first interval.

Referring to FIG. 10B, the transceiver 135b of the wireless audio transmitting device 50 may be configured to periodically output beacon signals BCa to Bnc and output an audio signal through the frequency channel and preamble code between the beacon signals BCa to Bnc.

The figure illustrates a case in which the audio signal Ifa is output using the frequency channel and preamble code H[0] during the period Pab, which is the interval between the beacon signals BCa and BCb, and the audio signal Ifb is output using the frequency channel and preamble code H[1] during the period Pbc, which is the interval between the beacon signals BCb and BCc.

Next, FIG. 10C illustrates a case in which the frequency hopping interval is a second interval that is longer than the first interval.

Referring to FIG. 10C, the transceiver 135b of the wireless audio transmitting device 50 may be configured to periodically output beacon signals BCa to Bnc and output an audio signal through the frequency channel and preamble code between the beacon signals BCa to Bnc.

The figure illustrates a case in which the audio signal Ifa is output using the frequency channel and preamble code H[0] during the period Pac, which is the interval between the beacon signals BCa and BCc.

Compared to FIG. 10B, the figure illustrates a case in which the frequency hopping interval is doubled, resulting in less frequent frequency hopping.

Meanwhile, the transceiver 135b of the wireless audio transmitting device 50 may be configured to variably adjust the frequency hopping interval according to the settings or the surrounding wireless environment.

In other words, the transceiver 135b of the wireless audio transmitting device 50 may be configured to adjust the interval at which the channel or preamble code information is changed according to the settings or the surrounding wireless environment. Accordingly, frequency hopping in ultra-wideband communication may be performed in consideration of the surrounding wireless environment.

FIG. 10D illustrates part of the MAC header 1000 within a beacon signal.

Referring to the figure, a vendor specific IE (not shown) may be added to the Header IEs 1010, which is part of the MAC header 1000 within the beacon signal, and the vendor specific IE may include the beacon sequence number to be changed, the channel to be changed, or the preamble code information.

Accordingly, frequency hopping using the beacon signal becomes possible, eliminating the need for additional signals and enabling stable transmission of audio signals.

FIG. 10E illustrates frequency hopping between the wireless audio transmitting device 50 and the wireless audio receiving device 100.

Referring to the figure, as shown in FIG. 10a(a), the wireless audio transmitting device 50 may be configured to output a beacon signal Bcm at time Tm, output an audio signal Ifa using the frequency channel and preamble code H[k′], output a beacon signal Bco at time To, and output a second audio signal Ifo using the frequency channel and preamble code H[k].

In response to the operation above, as shown in FIG. 10a(b), the wireless audio receiving device 100a may be configured to receive the beacon signal Bcm at time Tm, receive the audio signal Ifa using the frequency channel and preamble code H[k′], receive the beacon signal Bco at time To, and receive the second audio signal Ifo using the frequency channel and preamble code H[k].

FIG. 11A illustrates a case in which the first sound is output from the wireless audio receiving device 100a after the time point Tm in FIG. 10E, and FIG. 11b illustrates a case in which the second sound is output from the wireless audio receiving device 100a after the time point To in FIG. 10E.

Since the wireless audio receiving device 100a receives the audio signal Ifa after the time point Tm using the frequency channel and preamble code H[k′], the first sound Sa corresponding to the audio signal Ifa may be output.

Meanwhile, since the wireless audio receiving device 100a receives the audio signal Ifb after the time point To using the frequency channel and preamble code H[k], the second sound Sb corresponding to the second audio signal Ifa may be output. In this way, sound may be stably output according to frequency hopping.

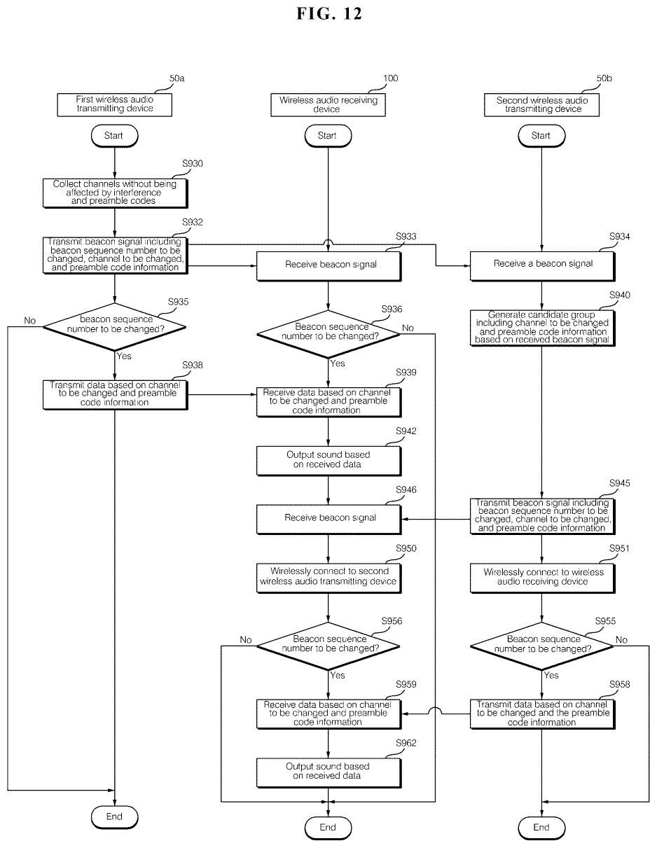

FIG. 12 is yet another example of a flowchart showing a method of operating a wireless audio output system according to an embodiment of the present disclosure.

Referring to the figure, in the frequency hopping mode, the transceiver 135b within the wireless audio transmitting device 50 of the wireless audio output system 10 according to an embodiment of the present disclosure may be configured to perform scanning of all channels and the entire preamble code information based on ultra-wideband communication.

Then, the transceiver 135b in the wireless audio transmitting device 50 may be configured to collect channels without being affected by interference and preamble codes S930.

In other words, the transceiver 135b in the wireless audio transmitting device 50 may be configured to collect channels in the idle state and preamble code information.

Then, the transceiver 135b in the wireless audio transmitting device 50 may be configured to generate a candidate list for frequency hopping, which includes the collected channels in the idle state and preamble code information.

Next, in the frequency hopping mode, the transceiver 135b in the wireless audio transmitting device 50 may be configured to wirelessly transmit a first beacon signal including a beacon sequence number to be changed, a channel to be changed, or preamble code information using the channel in the idle state or preamble code information from the candidate list S932.

In response to the operation above, the transceiver 135 in the wireless audio receiving device 100 of the wireless audio output system 10 may be configured to receive the first beacon signal including the beacon sequence number to be changed, the channel to be changed, or the preamble code information S933.

Also, the transceiver 135b in the second wireless audio transmitting device 50b of the wireless audio output system 10 may be configured to receive the first beacon signal including the beacon sequence number to be changed, the channel to be changed, or the preamble code information S934. Also, the transceiver 135b in the second wireless audio transmitting device 50b of the wireless audio output system 10 may be configured to generate a candidate group including a channel to be changed and preamble code information based on the received beacon signal S940.

Next, among the periodically output beacon signals, if a second beacon signal corresponding to the beacon sequence number to be changed in the first beacon signal output in the S932 step is output S935, the transceiver 135b in the wireless audio transmitting device 50 may be configured to transmit a wireless audio signal to the wireless audio receiving device 100 based on the channel to be changed or the preamble code information S938.

In other words, in response to the second beacon signal output after the first beacon signal corresponding to the beacon sequence number to be changed S935, the transceiver 135b in the wireless audio transmitting device 50 may be configured to transmit a wireless audio signal to the wireless audio receiving device 100 based on the channel to be changed or the preamble code information.

In response to the operation above, in response to the second beacon signal received after the first beacon signal corresponding to the beacon sequence number to be changed S936, the transceiver 135 in the wireless audio receiving device 100 may be configured to receive the wireless audio signal based on the channel to be changed or the preamble code information S939, and the sound output device 160 may be configured to output sound corresponding to the received wireless audio signal S942.

Next, based on the first beacon signal, the transceiver 135b in the second wireless audio transmitting device 50b may be configured to perform scanning of all channels and the entire preamble code information based on ultra-wideband communication.

Then, the transceiver 135b in the second wireless audio transmitting device 50b may be configured to collect channels without being affected by interference and preamble codes.

In other words, the transceiver 135b in the second wireless audio transmitting device 50b may be configured to collect channels in the idle state and preamble code information.

Then, the transceiver 135b in the second wireless audio transmitting device 50b may be configured to generate a frequency hopping candidate list including the collected channels in the idle state and preamble code information.

At this time, the frequency hopping candidate list may include channels in the idle state and preamble code information, excluding the channel to be changed or the preamble code information in the first beacon signal.

Then, in the frequency hopping mode, the transceiver 135b in the second wireless audio transmitting device 50b may be configured to wirelessly transmit a third beacon signal including the beacon sequence number to be changed, the channel to be changed, or the preamble code information using the channel in the idle state or preamble code information in the candidate list S945.

In response to the operation above, the transceiver 135 in the wireless audio receiving device 100 of the wireless audio output system 10 may be configured to receive the third beacon signal including the beacon sequence number to be changed, the channel to be changed, or the preamble code information from the second wireless audio transmitting device 50b S946.

Next, in response to receiving the third beacon signal from the second wireless audio transmitting device 50b, the transceiver 135 in the wireless audio receiving device 100 may be configured to transmit a connection request command to the second wireless audio transmitting device 50b and perform wireless connection to the second wireless audio transmitting device 50b S960.

At this time, in response to performing wireless connection with the second wireless audio transmitting device 50b, the transceiver 135 in the wireless audio receiving device 100 may be configured to terminate the wireless connection with the first wireless audio transmitting device 50.

In response to the operation above, the second wireless audio transmitting device 50b may be configured to receive the connection request command from the wireless audio receiving device 100 and perform wireless connection to the wireless audio receiving device 100 S951.

Next, among the beacon signals periodically output, when a fourth beacon signal corresponding to the beacon sequence number to be changed included in the third beacon signal output in the S945 step is output S955, the transceiver 135b in the second wireless audio transmitting device 50b is configured to transmit a wireless audio signal to the wireless audio receiving device 100 based on the channel to be changed or the preamble code information S958.

In other words, if the fourth beacon signal output after the third beacon signal corresponds to the beacon sequence number to be changed S955, the transceiver 135b in the second wireless audio transmitting device 50b is configured to transmit a second wireless audio signal to the wireless audio receiving device 100 based on the channel to be changed or the preamble code information.

In response to the operation above, if the fourth beacon signal received after the third beacon signal corresponds to the beacon sequence number to be changed S956, the transceiver 135 in the wireless audio receiving device 100 is configured to receive the second wireless audio signal based on the channel to be changed or the preamble code information S959, and the sound output device 160 is configured to output a second sound corresponding to the received second wireless audio signal S962.

Accordingly, frequency hopping in ultra-wideband communication may be performed using beacon signals. Furthermore, audio services based on ultra-wideband communication may be stably performed.

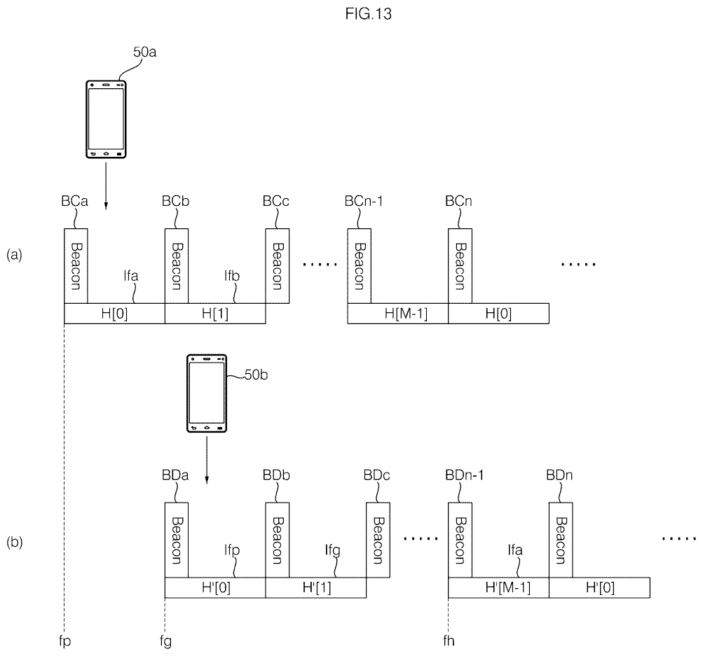

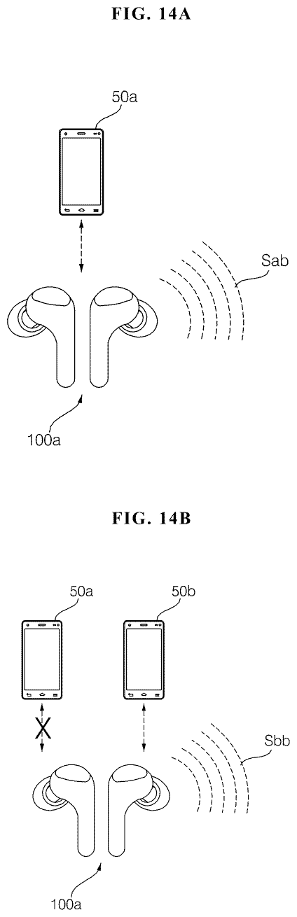

FIGS. 13 to 14B are diagrams referred to in description of FIG. 12.

First, FIG. 13 illustrates frequency hopping in the wireless audio transmitting device 50a and the second wireless audio transmitting device 50b, respectively.

Referring to the figure, as shown in FIG. 13(a), the wireless audio transmitting device 50a may periodically output beacon signals BCa to BCn and output an audio signal using the corresponding frequency channel and preamble code based on a candidate list generated by the wireless audio transmitting device 50a.

For example, the wireless audio transmitting device 50a may be configured to output an audio signal Ifa to the connected wireless audio receiving device 100 between the beacon signals BCa and BCb after the time point fp using the frequency channel and preamble code H[0] and may be configured to output an audio signal Ifb to the connected wireless audio receiving device 100 between the beacon signals BCb and BCc using the frequency channel and preamble code H[1].

Meanwhile, as shown in FIG. 13(b), the second wireless audio transmitting device 50b may be configured to periodically output beacon signals BDa to BDn and output an audio signal using the corresponding frequency channel and preamble code based on a candidate list generated by the second wireless audio transmitting device 50b.

For example, the second wireless audio transmitting device 50b may be configured to output an audio signal Ifp to the connected wireless audio receiving device 100 between the beacon signals BDa and BDb after the time point fg using the frequency channel and preamble code H′[0], output an audio signal Ifg to the connected wireless audio receiving device 100 between the beacon signals BDb and BDc using the frequency channel and preamble code H′[1], and output an audio signal Ifr to the connected wireless audio receiving device 100 between the beacon signals BDn-1 and BDn after the time point fh using the frequency channel and preamble code H′[M-1].

FIG. 14A illustrates a case in which the first sound is output from the wireless audio receiving device 100a after the time point fp in FIG. 13, and FIG. 14B illustrates a case in which the second sound is output from the wireless audio receiving device 100a after the time point fh in FIG. 13.

The wireless audio receiving device 100a may be configured to receive the audio signal Ifa from the wireless audio transmitting device 50a after the time point fp using the frequency channel and preamble code H[0] and output a first sound Sab corresponding to the audio signal Ifa.

Meanwhile, the wireless audio receiving device 100a may be configured to terminate the wireless connection with the wireless audio transmitting device 50a, wirelessly connect to the second wireless audio transmitting device 50b, receive the audio signal Ifr after the time point fh using the frequency channel and preamble code H′[M-1], and output a second sound Sbb corresponding to the second audio signal Ifr. In this way, sound may be stably output according to frequency hopping from various wireless audio transmitting devices.

Although the present disclosure has been described with reference to specific embodiments shown in the drawings, it is apparent to those skilled in the art that the present description is not limited to those exemplary embodiments and is embodied in many forms without departing from the scope of the present disclosure, which is described in the following claims. These modifications should not be individually understood from the technical spirit or scope of the present disclosure.

What is claimed is:

1. A wireless audio transmitting device comprising:
a display;
a processor configured to output an image signal to the display; and
a transceiver configured to wirelessly connect with a wireless audio receiving device through ultra-wideband communication,
wherein the transceiver is configured to output a first beacon signal including a beacon sequence number to be changed, a channel to be changed, or preamble code information and,
in response to a second beacon signal output after the first beacon signal corresponding to the beacon sequence number to be changed, transmit a wireless audio signal to the wireless audio receiving device based on the channel to be changed or the preamble code information.

2. The device of claim 1, wherein the transceiver is configured to:
output the first beacon signal further including current channel information and current preamble code information,
connect to the wireless audio receiving device after outputting the first beacon signal based on a connection request command received from the wireless audio receiving device and,
after connecting to the wireless audio receiving device, in response to the output second beacon signal corresponding to the beacon sequence number to be changed, transmit the wireless audio signal to the wireless audio receiving device based on the channel and the preamble code information.

3. The device of claim 1, wherein the transceiver is configured to:
transmit the first beacon signal after connecting to the wireless audio receiving device and,
in response to the second beacon signal output after the first beacon signal corresponding to the beacon sequence number to be changed, transmit the wireless audio signal to the wireless audio receiving device based on the channel to be changed or the preamble code information.

4. The device of claim 1, wherein the transceiver is configured to:
perform scanning of all channels and the entire preamble code information and collect information on idle channels and preamble codes and,
based on the collected channel and preamble code information, output the first beacon signal including the beacon sequence number to be changed, the channel to be changed, or the preamble code information.

5. The device of claim 4, wherein, based on the collected channel and preamble code information, the transceiver is configured to add a beacon sequence number to be additionally changed, a channel to be additionally changed, or preamble code information to the second beacon signal, and output the second beacon signal including the beacon sequence number to be changed, the channel to be changed, or the preamble code information.

6. The device of claim 4, wherein, based on the collected channel and preamble code information, the transceiver is configured to output a third beacon signal including a beacon sequence number to be additionally changed, a channel to be additionally changed, or preamble code information after the second beacon signal.

7. The device of claim 1, wherein, in the case of frequency hopping mode, the transceiver is configured to perform scanning of all channels and the entire preamble code information and collect information on idle channels and preamble codes and,
based on the collected channel and preamble code information, output the first beacon signal including the beacon sequence number to be changed, the channel to be changed, or the preamble code information.

8. The device of claim 1, wherein the transceiver includes a first communication module configured to perform wireless communication based on a first communication standard in a first frequency band; and
a second communication module configured to perform ultra-wideband communication in a frequency band higher than the first frequency band,
wherein a Personal Area Network (PAN) coordinator within the second communication module is configured to output the first beacon signal including the beacon sequence number to be changed, the channel to be changed, or the preamble code information.

9. The device of claim 8, wherein, in the case of frequency hopping mode, the PAN coordinator within the transceiver is configured to perform scanning of all channels and the entire preamble code information and collect information on idle channels and preamble codes and
output the first beacon signal including the beacon sequence number to be changed, the channel to be changed, or the preamble code information based on the collected channel and preamble code information.

10. The device of claim 1, wherein the transceiver is configured to change the interval of changing the channel or preamble code information based on a setting or surrounding wireless environment.

11. A wireless audio receiving device comprising:
a transceiver configured to perform wireless communication with a wireless audio transmitting device through ultra-wideband communication; and
a sound output device configured to output sound,
wherein the transceiver is configured to receive a first beacon signal including a beacon sequence number to be changed, a channel to be changed, or preamble code information and, in response to a second beacon signal received after the first beacon signal corresponding to the beacon sequence number to be changed, receive a wireless audio signal based on the channel to be changed or the preamble code information, and
wherein the sound output device is configured to output sound corresponding to the received wireless audio signal.

12. The device of claim 11, wherein the transceiver is configured to:
receive the first beacon signal further including current channel information and current preamble code information,
transmit a connection request command to the wireless audio transmitting device based on the first beacon signal,
connect to the wireless audio transmitting device based on the connection request command, and,
in response to the second beacon signal received after connecting to the wireless audio transmitting device corresponding to the beacon sequence number to be changed, receive the wireless audio signal based on the channel and the preamble code information.

13. The device of claim 11, wherein the transceiver is configured to:
receive the first beacon signal after connecting to the wireless audio transmitting device and,
in response to the second beacon signal received after the first beacon signal corresponding to the beacon sequence number to be changed, receive the wireless audio signal based on the channel to be changed or the preamble code information.

14. The device of claim 11, wherein the transceiver is configured to perform wireless connection to a second wireless audio transmitting device in response to receiving a third beacon signal including current channel information, current preamble code information, a beacon sequence number to be changed, a channel to be changed, or preamble code information from the second wireless audio transmitting device.

15. The device of claim 14, wherein, in response to performing wireless connection to the second wireless audio transmitting device, the transceiver is configured to terminate wireless connection to the wireless audio transmitting device.

16. The device of claim 14, wherein, in response to a fourth beacon signal received after connecting to the second wireless audio transmitting device corresponding to the beacon sequence number to be changed, the transceiver is configured to receive a second wireless audio signal based on the channel and the preamble code information, and
wherein the sound output device is configured to output a second sound corresponding to the second wireless audio signal received.

17. A wireless audio output system comprising:
the wireless audio transmitting device of any one of claims 1 to 10; and
the wireless audio receiving device of any one of claims 11 to 16.
